(19) United States
(12) Patent Application Publication
(10) Pub. No.: US 2026/0340883 A1
(43) Pub. Date: Oct. 29, 2026

(54) CONTEXT-AWARE VOXEL-BASED UPSAMPLING FOR POINT CLOUD PROCESSING

(71) Applicant: InterDigital VC Holdings, Inc., Wilmington, DE (US)

(72) Inventors: Jiahao Pang, Plainsboro, NJ (US); Kevin Bui, Elk Grove, CA (US); Dong Tian, Boxborough, MA (US)

(21) Appl. No.: 19/119,660

(22) PCT Filed: Oct. 17, 2023
(86) PCT No.: PCT/US2023/035320

§ 371 Date: Apr. 9, 2025

Related U.S. Application Data
(60) Provisional application No. 63/417,284, filed on Oct. 18, 2022.
(60) Provisional application No. 63/438,212, filed on Jan. 10, 2023.

(51) Int. Cl. G06T 9/00; G06T 3/4053

(52) U.S. Cl. CPC G06T 9/002; G06T 3/4053; G06T 9/001

(57) ABSTRACT

Some embodiments of a method may include upsampling a first point cloud using initial upsampling to obtain a second point cloud; associating features of the second point cloud with context information to obtain a third point cloud; predicting occupancy status of at least one voxel of the third point cloud; and removing voxels of the third point cloud that are classified as empty, according to the predicted occupancy status, to generate a pruned point cloud.

### CROSS-REFERENCE TO RELATED APPLICATIONS

The present application is an International Application, which claims benefit under 35 U.S.C. § 119(e) from U.S. Provisional Patent Application Ser. No. 63/438,212, entitled “CONTEXT-AWARE VOXEL-BASED UPSAMPLING FOR POINT CLOUD PROCESSING” and filed Jan. 10, 2023 (“'212 application”), and U.S. Provisional Patent Application Ser. No. 63/417,284, entitled “CONTEXT-AWARE VOXEL-BASED UPSAMPLING FOR POINT CLOUD PROCESSING” and filed Oct. 18, 2022, (“284 application”), which are hereby incorporated by reference in their entirety.

### INCORPORATION BY REFERENCE

The present application incorporates by reference in their entirety the following applications: U.S. Provisional Patent Application Ser. No. 63/291,015, entitled “Hybrid Framework for Point Cloud Compression” and filed Dec. 17, 2021 (“'015 application”); U.S. Provisional Patent Application Ser. No. 63/297,869, entitled “A Scalable Framework for Point Cloud Compression” and filed Jan. 10, 2022 (“'869 application”); U.S. Provisional Patent Application Ser. No. 63/388,087, entitled “A Scalable Framework for Point Cloud Compression” and filed Jul. 11, 2022 (“'087 application”); U.S. Provisional Patent Application Ser. No. 63/252,482, entitled “Method and Apparatus for Point Cloud Compression Using Hybrid Deep Entropy Coding” and filed Oct. 5, 2021 (“'482 application”); U.S. Provisional Patent Application Ser. No. 63/297,894, entitled “Coordinate Refinement and Upsampling from Quantized Point Cloud Reconstruction” and filed Jan. 10, 2022 (“'894 application”); and U.S. Provisional Patent Application Ser. No. 63/388,600, entitled “Deep Distribution-Aware Point Feature Extractor for AI-Based Point Cloud Compression” and filed Jul. 12, 2022 (“'600 application”).

### BACKGROUND

Point Cloud (PC) data format is a universal data format across several business domains, e.g., autonomous driving, robotics, augmented reality/virtual reality (AR/VR), civil engineering, computer graphics, and the animation/movie industry. 3D LiDAR (Light Detection and Ranging) sensors have been deployed in self-driving cars, and affordable LiDAR sensors are available. With advances in sensing technologies, 3D point cloud data becomes more practical than ever.

### SUMMARY

Embodiments described herein include methods that are used in video encoding and decoding (collectively “coding”).

A first example method/apparatus in accordance with some embodiments may include: upsampling a first point cloud using initial upsampling to obtain a second point cloud; associating features of the second point cloud with context information to obtain a third point cloud; predicting an occupancy status of at least one voxel of the third point cloud; and removing voxels of the third point cloud that are classified as empty, according to the predicted occupancy status, to generate a pruned point cloud.

For some embodiments of the first example method, the initial upsampling includes nearest-neighbor upsampling.

For some embodiments of the first example method, associating features includes concatenating the features of the second point cloud with the context information to obtain the third point cloud.

For some embodiments of the first example method, the context information is voxel-wise context information.

For some embodiments of the first example method, the context information includes a context point cloud.

For some embodiments of the first example method, the context information includes information about the second point cloud.

For some embodiments of the first example method, the context information includes information about voxel occupancy status of the second point cloud.

For some embodiments of the first example method, the context information includes information regarding a position of a child voxel relative to a position of a parent voxel of the first point cloud.

For some embodiments of the first example method, the context information includes coordinate information regarding a position of an occupied voxel of at least one of the first and second point clouds.

For some embodiments of the first example method, the context information includes coordinate information, and the coordinate information is in a form of one of Euclidean coordinates, spherical coordinates, and cylindrical coordinates.

For some embodiments of the first example method, the context information provides known information regarding the first point cloud additional to information available to the initial upsampling of the first point cloud.

For some embodiments of the first example method, the context information includes a bit depth of the second point cloud.

Some embodiments of the first example method may further include performing a feature decode on an input point cloud and a first bitstream to generate the first point cloud.

Some embodiments of the first example method may further include: performing a feature aggregation on the pruned point cloud to generate an aggregated feature; and performing a context-aware upsampling process on the aggregated feature to generate a decoded point cloud.

Some embodiments of the first example method may further include: performing a feature to residual conversion on the pruned point cloud to generate a residual output; and adding the pruned point cloud to the residual output to generate a decoded point cloud.

Some embodiments of the first example method may further include performing a feature aggregation on the pruned point cloud to generate an aggregated feature, wherein the feature to residual conversion is performed on the aggregated feature.

For some embodiments of the first example method, predicting the occupancy status is performed using a first neural network.

For some embodiments of the first example method, predicting the occupancy status predicts a ground-truth occupancy status of at least one voxel.

For some embodiments of the first example method, predicting the occupancy status predicts a likelihood that the at least one voxel is occupied.

For some embodiments of the first example method, removing voxels of the third point cloud removes voxels using a voxel pruning process.

Some embodiments of the first example method may further include aggregating at least one feature of the second point cloud.

For some embodiments of the first example method, predicting the occupancy status of at least one voxel includes: aggregating at least one feature of the third point cloud; processing the aggregated feature with multi-layer perception (MLP) layers to generate an MLP layer output; performing a softmax process on the MLP layer output to generate softmax output values; and performing thresholding of the softmax output values to generate the predicted occupancy status of at least one voxel of the third point cloud.

For some embodiments of the first example method, thresholding of the softmax output values converts softmax output values greater than 0.5 into an output value of 1 and converts softmax output values equal to 0.5 or less into an output value of 0.

For some embodiments of the first example method, predicting the occupancy status of at least one voxel includes: aggregating at least one feature of the third point cloud; and generating the predicted occupancy status of at least one voxel of the third point cloud based on the aggregated feature.

For some embodiments of the first example method, aggregating at least one feature includes: repeating a cascading process one or more times, the cascading process including: performing a sparse 3D convolution of an input point cloud to generate a convolution output point cloud; performing a nonlinear activation process on the convolution output point cloud to generate a nonlinear output point cloud; and preparing the nonlinear output point cloud to be the input point cloud if there is to be a next cycle of the cascading process, wherein the third point cloud is the input point cloud for a first cycle of the cascading process, and wherein a last cycle of the cascading process generates the aggregated feature.

Some embodiments of the first example method may further include adding the third point cloud to the ReLU output point cloud of the last cycle of the cascading process.

For some embodiments of the first example method, aggregating at least one feature includes: performing a sparse 3D convolution of an input point cloud to generate a convolution output point cloud; and performing a nonlinear activation process on the convolution output point cloud to generate the aggregated feature.

For some embodiments of the first example method, the nonlinear activation process includes a rectifier linear unit (ReLU) activation process, and the nonlinear output point cloud includes a ReLU output point cloud.

For some embodiments of the first example method, aggregating at least one feature includes: repeating a first cascading process one or more times, the first cascading process including: performing a first sparse 3D convolution of a first input point cloud to generate a first convolution output point cloud; performing a first nonlinear activation process on the first convolution output point cloud to generate a first nonlinear output point cloud; and preparing the first nonlinear output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second nonlinear activation process on the second convolution output point cloud to generate a second nonlinear output point cloud; and preparing the second nonlinear output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the first example method, aggregating at least one feature includes: repeating a first cascading process one or more times, the first cascading process including: performing a first sparse 3D convolution of a first input point cloud to generate a first convolution output point cloud; performing a first rectifier linear unit (ReLU) activation process on the first convolution output point cloud to a first generate a ReLU output point cloud; and preparing the first ReLU output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second rectifier linear unit (ReLU) activation process on the second convolution output point cloud to generate a second ReLU output point cloud; and preparing the second ReLU output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the first example method, aggregating at least one feature includes: performing a self-attention process on the third point cloud; adding the third point cloud to the self-attention process output to generate an MLP process input; performing an MLP process on the MLP process input; and adding the MLP process input to the MLP process output to generate the aggregated feature;

For some embodiments of the first example method, the self-attention process generates an output feature based on k nearest neighbors of a voxel of the third point cloud.

For some embodiments of the first example method, aggregating at least one feature of the third point cloud includes performing a feature aggregation process two or more times.

A first example method/apparatus in accordance with some embodiments may include: a processor; and a non-transitory computer-readable medium storing instructions operative, when executed by the processor, to cause the apparatus to: upsample a first point cloud using initial upsampling to obtain a second point cloud; associate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

For some embodiments of the first example apparatus, the initial upsampling includes nearest-neighbor upsampling.

For some embodiments of the first example apparatus, associating features includes concatenating the features of the second point cloud with the context information to obtain the third point cloud.

An example device in accordance with some embodiments may include: an apparatus according to an apparatus listed above; and at least one of (i) an antenna configured to receive a signal, the signal including data representative of the image, (ii) a band limiter configured to limit the received signal to a band of frequencies that includes the data representative of the image, or (iii) a display configured to display the image.

Some embodiments of the example device may further include at least one of a TV, a cell phone, a tablet, and a set top box (STB).

An example computer-readable medium in accordance with some embodiments may include instructions for causing one or more processors to: upsample a first point cloud using initial upsampling to obtain a second point cloud; associate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

An example computer program product in accordance with some embodiments may include instructions which, when the program is executed by one or more processors, causes the one or more processors to: upsample a first point cloud using initial upsampling to obtain a second point cloud; associate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

A second example method in accordance with some embodiments may include performing context aware upsampling of a first point cloud to determine an upsampled second point cloud, wherein the context aware upsampling includes: associating features of a third point cloud with context information, the third point cloud being based at least in part on an initial upsampled version of the first point cloud; and removing voxels of a fourth point cloud predicted to be empty based at least in part on the context information from the third point cloud to generate the upscaled second point cloud.

A third example method in accordance with some embodiments may include: upsampling a first point cloud using initial upsampling to obtain a second point cloud; associating features of the second point cloud with context information to obtain a third point cloud; predicting an occupancy status of at least one voxel of the third point cloud, wherein predicting the occupancy status of at least one voxel includes aggregating at least one feature of the third point cloud, wherein aggregating at least one feature of the third point cloud includes using a first neural network, and wherein using the first neural network to aggregate at least one feature of the third point cloud includes using a first set of neural network parameters with the first neural network; removing voxels of the third point cloud that are classified as empty, according to the predicted occupancy status, to generate a pruned point cloud; and performing a feature aggregation on the pruned point cloud to generate an aggregated feature, wherein performing the feature aggregation on the pruned point cloud includes using a second neural network, wherein using the second neural network to generate the aggregated feature includes using a second set of neural network parameters with the second neural network, and wherein the first set of neural network parameters is identical to the second set of neural network parameters.

Some embodiments of the third example method may further include aggregating at least one feature of the second point cloud.

For some embodiments of the third example method, wherein aggregating at least one feature of the second point cloud includes using a third neural network, wherein using the third neural network to aggregate at least one feature of the second point cloud includes using a third set of neural network parameters with the third neural network, and wherein the third set of neural network parameters is identical to the first set of neural network parameters.

For some embodiments of the third example method, the initial upsampling includes nearest-neighbor upsampling.

For some embodiments of the third example method, associating features includes concatenating the features of the second point cloud with the context information to obtain the third point cloud.

For some embodiments of the third example method, associating features includes concatenating the features of the second point cloud with the context information to obtain the third point cloud.

For some embodiments of the third example method, the context information is voxel-wise context information.

Some embodiments of the third example method may further include performing a feature decode on an input point cloud and a first bitstream to generate the first point cloud.

Some embodiments of the third example method may further include performing a context-aware upsampling process on the aggregated feature to generate a decoded point cloud.

Some embodiments of the third example method may further include performing a feature to residual conversion on the pruned point cloud to generate a residual output; and adding the pruned point cloud to the residual output to generate a decoded point cloud.

For some embodiments of the third example method, the feature to residual conversion is performed on the aggregated feature.

For some embodiments of the third example method, predicting the occupancy status predicts a ground-truth occupancy status of at least one voxel.

For some embodiments of the third example method, predicting the occupancy status predicts a likelihood that the at least one voxel is occupied.

For some embodiments of the third example method, removing voxels of the third point cloud removes voxels using a voxel pruning process.

For some embodiments of the third example method, predicting the occupancy status of at least one voxel further includes: processing the aggregated feature with multi-layer perception (MLP) layers to generate an MLP layer output; performing a softmax process on the MLP layer output to generate softmax output values; and performing thresholding of the softmax output values to generate the predicted occupancy status of at least one voxel of the third point cloud.

For some embodiments of the third example method, thresholding of the softmax output values converts softmax output values greater than 0.5 into an output value of 1 and converts softmax output values equal to 0.5 or less into an output value of 0.

For some embodiments of the third example method, predicting the occupancy status of at least one voxel includes: aggregating at least one feature of the third point cloud; and generating the predicted occupancy status of at least one voxel of the third point cloud based on the aggregated feature.

For some embodiments of the third example method, aggregating at least one feature of the third point cloud includes: repeating a cascading process one or more times, the cascading process including: performing a sparse 3D convolution of an input point cloud to generate a convolution output point cloud; performing a nonlinear activation process on the convolution output point cloud to generate a nonlinear output point cloud; and preparing the nonlinear output point cloud to be the input point cloud if there is to be a next cycle of the cascading process, wherein the third point cloud is the input point cloud for a first cycle of the cascading process, and wherein a last cycle of the cascading process generates the aggregated feature.

Some embodiments of the third example method may further include adding the third point cloud to the ReLU output point cloud of the last cycle of the cascading process.

For some embodiments of the third example method, aggregating at least one feature includes: performing a sparse 3D convolution of an input point cloud to generate a convolution output point cloud; and performing a nonlinear activation process on the convolution output point cloud to generate the aggregated feature.

For some embodiments of the third example method, the nonlinear activation process includes a rectifier linear unit (ReLU) activation process, and the nonlinear output point cloud includes a ReLU output point cloud.

For some embodiments of the third example method, aggregating at least one feature of the third point cloud includes: repeating a first cascading process one or more times, the first cascading process including: performing a first sparse 3D convolution of a first input point cloud to generate a first convolution output point cloud; performing a first nonlinear activation process on the first convolution output point cloud to generate a first nonlinear output point cloud; and preparing the first nonlinear output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second nonlinear activation process on the second convolution output point cloud to generate a second nonlinear output point cloud; and preparing the second nonlinear output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the third example method, aggregating at least one feature includes: repeating a first cascading process one or more times, the first cascading process including: performing a first sparse 3D convolution of a first input point cloud to generate a first convolution output point cloud; performing a first rectifier linear unit (ReLU) activation process on the first convolution output point cloud to a first generate a ReLU output point cloud; and preparing the first ReLU output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second rectifier linear unit (ReLU) activation process on the second convolution output point cloud to generate a second ReLU output point cloud; and preparing the second ReLU output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the third example method, aggregating at least one feature includes: performing a self-attention process on the third point cloud; adding the third point cloud to the self-attention process output to generate an MLP process input; performing an MLP process on the MLP process input; and adding the MLP process input to the MLP process output to generate the aggregated feature;

For some embodiments of the third example method, the self-attention process generates an output feature based on k nearest neighbors of a voxel of the third point cloud.

For some embodiments of the third example method, aggregating at least one feature of the third point cloud includes performing a feature aggregation process two or more times.

For some embodiments of the third example method, the first set of neural network parameters and the second set of neural network parameters are the same set of neural network parameters, the same set of neural network parameters being used by at least the first neural network and the second neural network.

For some embodiments of the third example method, the first set of neural network parameters and the second set of neural network parameters are distinct but identical sets of neural network parameters.

A fourth example method in accordance with some embodiments may include: obtaining a first point cloud; determining an occupancy status of at least one voxel of the first point cloud; removing voxels of the first point cloud that are classified as empty, according to the determined occupancy status, to generate a second point cloud; associating features of the second point cloud with context information to obtain a third point cloud; downsampling the third point cloud using initial downsampling to obtain a fourth point cloud; and outputting the fourth point cloud as an encoded point cloud.

A fourth example apparatus in accordance with some embodiments may include: a processor; and a non-transitory computer-readable medium storing instructions operative, when executed by the processor, to cause the apparatus to: obtain a first point cloud; determine an occupancy status of at least one voxel of the first point cloud; remove voxels of the first point cloud that are classified as empty, according to the determined occupancy status, to generate a second point cloud; associate features of the second point cloud with context information to obtain a third point cloud; downsample the third point cloud using initial downsampling to obtain a fourth point cloud; and output the fourth point cloud as an encoded point cloud.

A fifth example method/apparatus in accordance with some embodiments may include: accessing data including a first point cloud; and transmitting the data including the first point cloud.

A fifth example method/apparatus in accordance with some embodiments may include: an accessing unit configured to access data including a first point cloud; and a transmitter configured to transmit the data including the first point cloud.

A sixth example method/apparatus in accordance with some embodiments may include: a processor; and a non-transitory computer-readable medium storing instructions operative, when executed by the processor, to cause the apparatus to perform any one of the methods listed above.

A seventh example method/apparatus in accordance with some embodiments may include at least one processor configured to perform any one of the methods listed above.

An eighth example method/apparatus in accordance with some embodiments may include a computer-readable medium storing instructions for causing one or more processors to perform any one of the methods listed above.

A ninth example method/apparatus in accordance with some embodiments may include at least one processor and at least one non-transitory computer-readable medium storing instructions for causing the at least one processor to perform any one of the methods listed above.

An example signal in accordance with some embodiments may include a bitstream generated according to any one of the methods listed above.

In additional embodiments, encoder and decoder apparatus are provided to perform the methods described herein. An encoder or decoder apparatus may include a processor configured to perform the methods described herein. The apparatus may include a computer-readable medium (e.g. a non-transitory medium) storing instructions for performing the methods described herein. In some embodiments, a computer-readable medium (e.g. a non-transitory medium) stores a video encoded using any of the methods described herein.

One or more of the present embodiments also provide a computer readable storage medium having stored thereon instructions for performing bi-directional optical flow, encoding or decoding video data according to any of the methods described above. The present embodiments also provide a computer readable storage medium having stored thereon a bitstream generated according to the methods described above. The present embodiments also provide a method and apparatus for transmitting the bitstream generated according to the methods described above. The present embodiments also provide a computer program product including instructions for performing any of the methods described.

### BRIEF DESCRIPTION OF THE DRAWINGS

FIG. 1A is a system diagram illustrating an example communications system according to some embodiments.

FIG. 1B is a system diagram illustrating an example wireless transmit/receive unit (WTRU) that may be used within the communications system illustrated in FIG. 1A according to some embodiments.

FIG. 1C is a system diagram illustrating an example set of interfaces for a system according to some embodiments.

FIG. 2A is a schematic illustration showing an example voxel-based representation of a point cloud.

FIG. 2B is a schematic illustration showing an example sparse voxel-based representation of a point cloud.

FIG. 3 is a schematic process diagram showing an example nearest-neighbor (NN) upsampling for a point cloud.

FIG. 4 is a schematic process diagram showing an example voxel-based upsampling with pruning.

FIG. 5 is a schematic process diagram showing an example context-aware voxel-based upsampling with pruning according to some embodiments.

FIG. 6A is a table illustrating example position values according to some embodiments.

FIG. 6B is a schematic perspective view illustrating example child voxel positions as context information according to some embodiments.

FIG. 7 is a flowchart illustrating an example process for cascading several context-aware upsamplings according to some embodiments.

FIG. 8 is a schematic process diagram showing an example context-aware voxel-based upsampling with initial feature aggregation according to some embodiments.

FIG. 9 is a flowchart illustrating an example process for binary classification according to some embodiments.

FIG. 10 is a block diagram illustrating an example process with cascaded sparse convolutional layers for feature aggregation according to some embodiments.

FIG. 11 is a block diagram illustrating an example ResNet block for feature aggregation according to some embodiments.

FIG. 12 is a block diagram illustrating an example Inception-ResNet block for feature aggregation according to some embodiments.

FIG. 13 is a block diagram illustrating an example transformer block for feature aggregation according to some embodiments.

FIG. 14 is a block diagram illustrating an example architecture of a self-attention block according to some embodiments.

FIG. 15 is a flowchart illustrating an example process for cascading several feature aggregations according to some embodiments.

FIG. 16 is a block diagram illustrating an example original decoder architecture according to some embodiments.

FIG. 17 is a block diagram illustrating an example decoder architecture with voxel-based upsampling according to some embodiments.

FIG. 18 is a block diagram illustrating an example decoder architecture with voxel-based upsampling and feature aggregation according to some embodiments.

FIG. 19 is a block diagram illustrating an example decoder architecture without a feature-to-residual converter according to some embodiments.

FIG. 20 is a block diagram illustrating an example decoder architecture with a single progression through voxel-based upsampling and feature aggregation according to some embodiments.

FIG. 21 is a block diagram illustrating example sparse tensor operations according to some embodiments.

FIG. 22 is a block diagram illustrating an example decoder architecture according to some embodiments.

FIG. 23 is a block diagram illustrating an example decoder architecture according to some embodiments.

FIG. 24 is a flowchart illustrating an example process of context-aware voxel-based upsampling with pruning according to some embodiments.

FIG. 25 is a flowchart illustrating an example process of context-aware voxel-based upsampling and feature aggregation according to some embodiments.

FIG. 26 is a flowchart illustrating an example process of encoding a bitstream according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

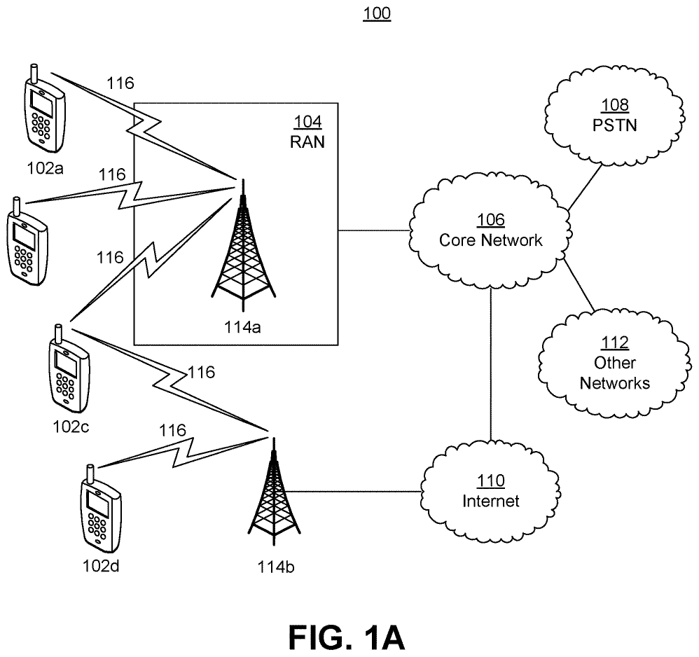

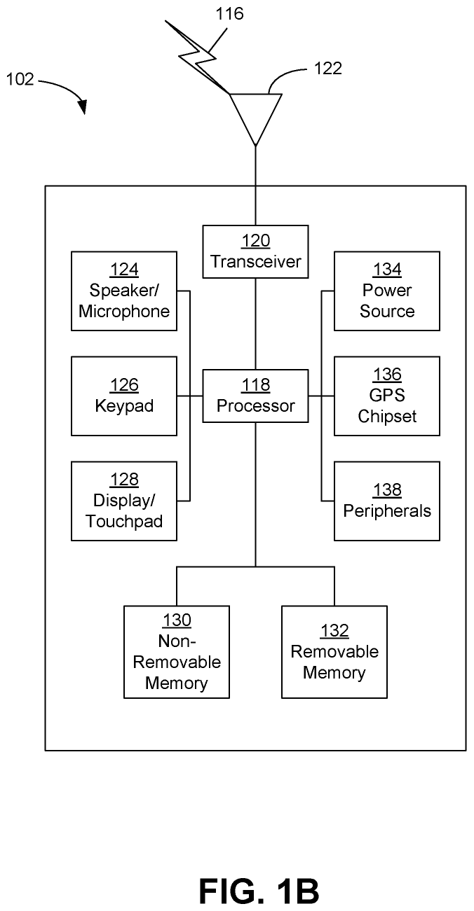

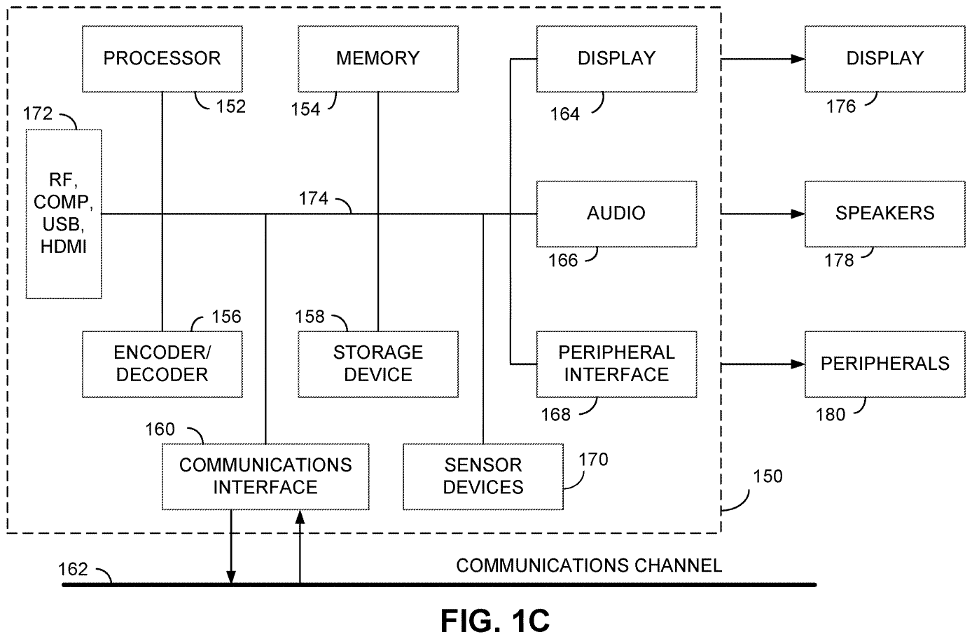

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104/113 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106 may be in direct or indirect communication with other RANs that employ the same RAT as the RAN 104/113 or a different RAT. For example, in addition to being connected to the RAN 104/113, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, alight sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1C is a system diagram illustrating an example set of interfaces for a system according to some embodiments. An extended reality display device, together with its control electronics, may be implemented. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 1000 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV.Link, Consumer Electronics Control (CEC), or other communications protocols that enable device-to-device control with or without user intervention. The output devices can be communicatively coupled to system 1000 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

This application discusses point cloud processing and compression, which includes processing, compression, representation, analysis, and understanding of point cloud signals. Furthermore, this application discusses an adaptive, voxel-based point cloud upsampling method based on deep neural networks, including some embodiments applied to point cloud processing and compression. This application also discusses performing upsampling in the voxel domain.

Point cloud data may consume a large portion of network traffic, e.g., among connected cars over a 5G network and in immersive (e.g., AR/VR/MR) communications. Efficient representation formats may be used for point clouds and communication. In particular, raw point cloud data may be organized and processed for modeling and sensing, such as the world, an environment, or a scene. Compression of raw point clouds may be used with storage and transmission of the data.

Furthermore, point clouds may represent sequential scans of the same scene, which may contain multiple moving objects. Dynamic point clouds capture moving objects, while static point clouds capture a static scene and/or static objects. Dynamic point clouds may be typically organized into frames, with different frames being captured at different times. The processing and compression of dynamic point clouds may be performed in real-time or with a low amount of delay.

The automotive industry, including autonomous vehicles, for example, may use point clouds. Autonomous cars “probe” their environment to make driving decisions based on their immediate surroundings. Typically, LiDAR sensors produce (dynamic) point clouds that are used by a perception engine. Furthermore, typically, these point clouds are dynamic with a high capture frequency, sparse, not necessarily colored, and not viewed by human eyes. Such point clouds may include other attributes, such as the reflectance ratio provided by the LiDAR which may be indicative of the material of a sensed object and may be used in making a decision.

The automotive industry and autonomous car are some of the domains in which point clouds may be used. Autonomous cars “probe” and sense their environment to make good driving decisions based on the reality of their immediate surroundings. Sensors such as LiDARs produce (dynamic) point clouds that are used by a perception engine. These point clouds typically are not intended to be viewed by human eyes, and these point clouds may or may not be colored and are typically sparse and dynamic with a high frequency of capture. Such point clouds may have other attributes like the reflectance ratio provided by the LiDAR because this attribute is indicative of the material of the sensed object and may help in making a decision.

Virtual Reality (VR) and immersive worlds have become a hot topic and are foreseen by many as the future of 2D flat video. The viewer may be immersed in an all-around environment, as opposed to standard TV where the viewer only looks at a virtual world in front of the viewer. There are several gradations in the immersivity depending on the freedom of the viewer in the environment. Point cloud formats may be used to distribute VR worlds and environment data. Such point clouds may be static or dynamic and are typically average size, such as less than several millions of points at a time.

Point clouds also may be used for various other purposes, such as scanning of cultural heritage objects and/or buildings in which objects such as statues or buildings are scanned in 3D. The spatial configuration data of the object may be shared without sending or visiting the actual object or building. Also, this data may be used to preserve knowledge of the object in case the object or building is destroyed, such as a temple by an earthquake. Such point clouds, typically, are static, colored, and huge in size.

Another use case is in topography and cartography using 3D representations, in which maps are not limited to a plane and may include the relief. Google Maps, for example, may use meshes instead of point clouds for their 3D maps. Nevertheless, point clouds may be a suitable data format for 3D maps, and such point clouds, typically, are also static, colored, and huge in size.

World modeling and sensing via point clouds may allow machines to record and use spatial configuration data about the 3D world around them, which may be used in the applications discussed above.

3D point cloud data include discrete samples of surfaces of objects or scenes. To fully represent the real world with point samples, a huge number of points may be used. For instance, a typical VR immersive scene includes millions of points, while point clouds typically may include hundreds of millions of points. Therefore, the processing of such large-scale point clouds is computationally expensive, especially for consumer devices, e.g., smartphones, tablets, and automotive navigation systems, which may have limited computational power.

To store and process the input point cloud with affordable computational cost, the input point cloud may be down-sampled, in which the down-sampled point cloud summarizes the geometry of the input point cloud while having much fewer points. The down-sampled point cloud is inputted into a subsequent machine task for further processing. The down-sampled point cloud may be processed by gradually upsampling the point cloud. In particular, for some embodiments, a learning-based autoencoder architecture may use downsampling for feature extraction and upsampling for reconstruction. Such upsampling, for example, may be used with point cloud compression (e.g., on the decoder) and with point cloud super-resolution. Among other things, this application discusses examples of adaptive point cloud upsampling methods, in according with some embodiments.

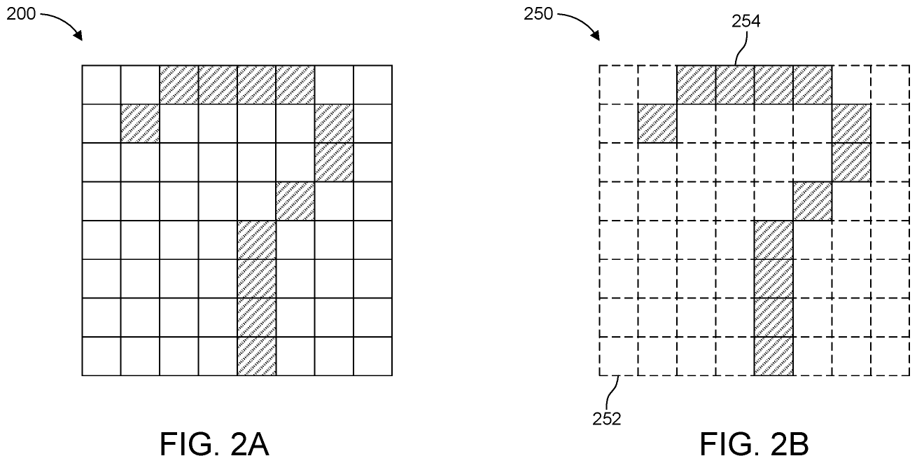

FIG. 2A is a schematic illustration showing an example voxel-based representation of a point cloud. In a voxel-based representation of point cloud data, the 3D point coordinates are uniformly quantized by a quantization step. Each point in the representation 200 corresponds to an occupied voxel with a size equal to the quantization step, as shown in FIG. 2A. “Naïve” voxel representations may not be efficient in memory usage because most voxels may generally be empty. Sparse voxel representations are then introduced where the occupied voxels are arranged in a sparse tensor format for efficient storage and processing.

FIG. 2B is a schematic illustration showing an example sparse voxel-based representation of a point cloud. In the example of a sparse voxel representation 250 depicted in FIG. 2B, an empty voxel 252 (with dotted lines) does not necessarily consume as much memory or storage as an occupied voxel 254 (with solid diagonal lines).

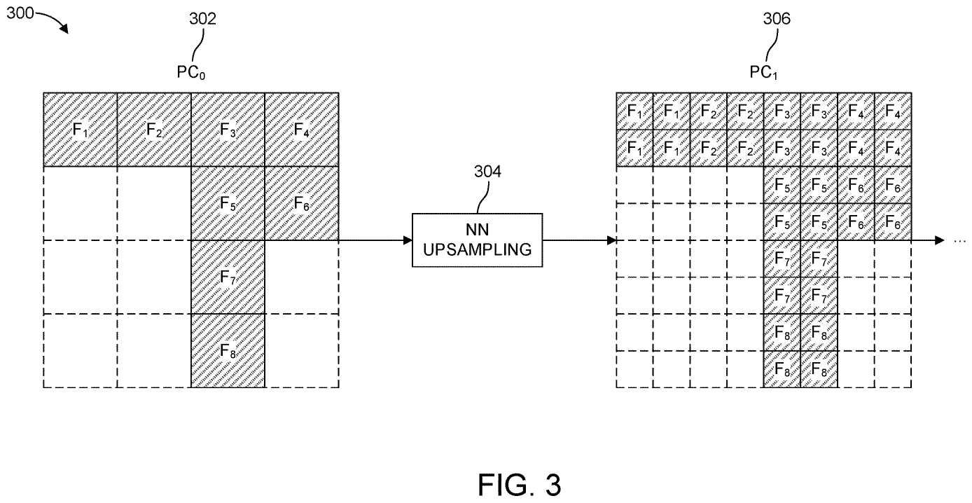

Note that FIGS. 2A and 2B and the rest of the figures, including FIGS. 3, 4, 5, 8, and 9, point clouds are illustrated in 2D just for purposes of explanation and simplification, and the concepts may generally apply to and be extended to 3D.

By representing point clouds as 3D voxels, point clouds may be processed (digested) with 3D convolutional neural networks. Applying 2D convolutional neural networks to 2D images has been successful. With regular 3D convolutions, a 3D kernel is overlaid on every location specified by a stride step no matter whether the voxels are occupied or empty. Stride indicates the amount of movement or step size over the 3D voxel grids when applying the convolution. If the step size is set to 1, the 3D kernel is typically sliding through every voxel in the 3D space to compute the output. In this case, the dimension of the output voxel space (height, width, depth) is the same as that of the input voxel space. If the stride step is set to 2, the 3D kernel is sliding every other two voxels to compute the output. In this case, every dimension of the output voxel space becomes half of the input voxel space. An empty voxel is a voxel in which there are no 3D points at the position of that voxel. To avoid computation and memory consumption incurred by empty voxels, sparse 3D convolutional layers may be applied if the point cloud voxels are represented by a sparse tensor.

FIG. 3 is a schematic process diagram showing an example nearest-neighbor (NN) upsampling for a point cloud. To perform, for example, a two-times (2×) upsampling in the voxel domain, an occupied voxel is split into two voxels along all x, y, and z directions. Thus, one (occupied) parent voxel becomes 8 (=2³) occupied child voxels after upsampling, and the resolution of the point cloud is upsampled by two times in each dimension (x, y, and z). According to this example approach, if there is any feature vector associated with a parent voxel, this feature vector will be directly inherited by its 8 child voxels. The mechanism of this upsampling approach is depicted in FIG. 3 and is referenced as nearest-neighbor (NN) upsampling. For the example of FIG. 3, after the input point cloud 302 is NN upsampled 304, the output point cloud 306 and its features are inputted to the subsequent pipeline for additional processing.

There are some shortcomings to this NN upsampling approach. Firstly, after upsampling, the geometry of the point cloud is a naïve enlargement of the original geometry—there is not any refinement in terms of the shape of the point cloud. Secondly, the number of occupied voxels after upsampling is always eight times the original one, which may incur a high computational cost in the subsequent processing.

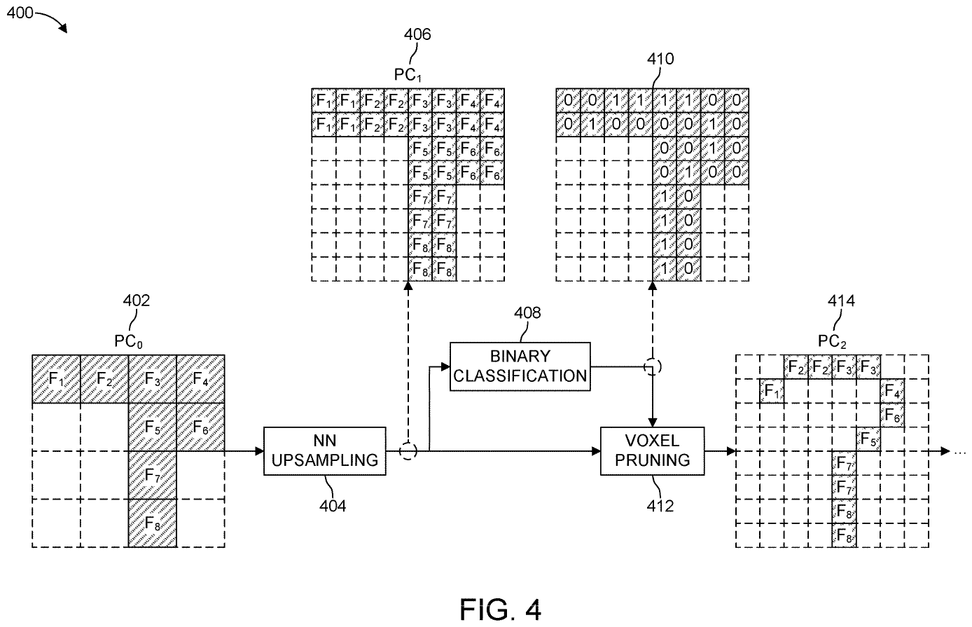

FIG. 4 is a schematic process diagram showing an example voxel-based upsampling with pruning. In the article, Wang, Jianqiang, et al., Multiscale Point Cloud Geometry Compression, 2021 DATA COMPRESSION CONFERENCE (DCC) 73-82, IEEE (2021) (“Wang”), the authors proposed a method to additionally refine the upsampled geometry by binary classification and voxel pruning. FIG. 4 shows the approach taken in Wang.

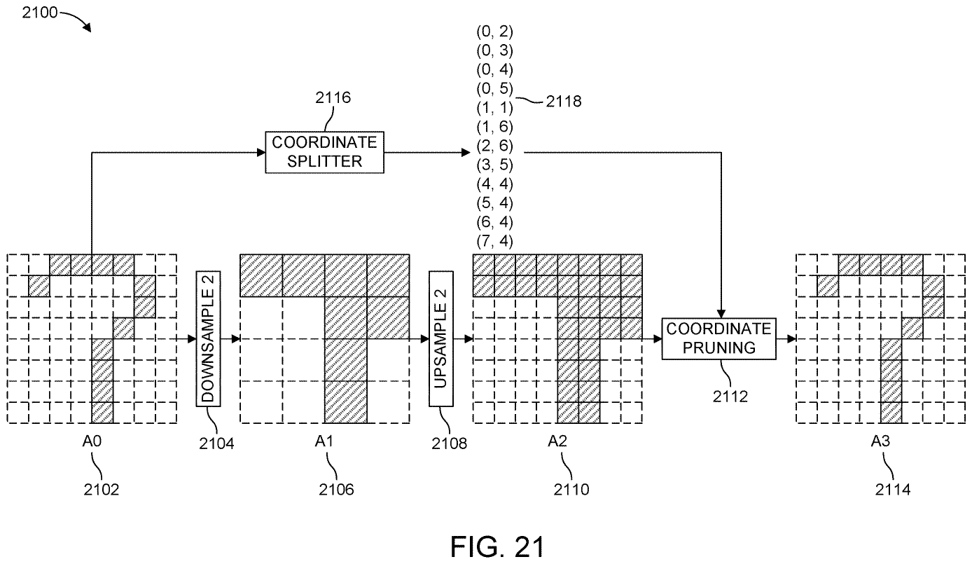

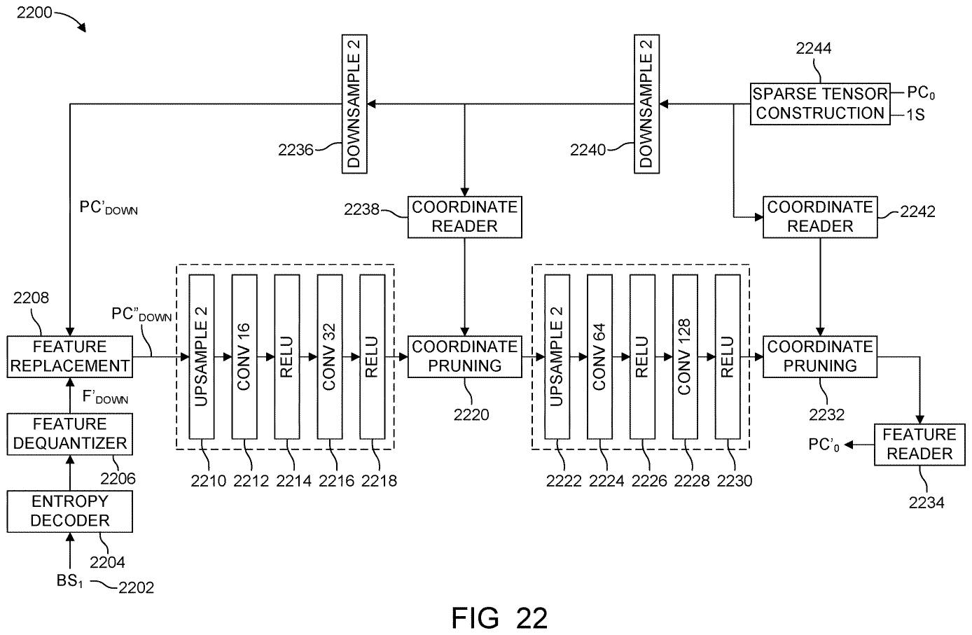

According to the example approach 400, the input point cloud PC₀ 402 is first upsampled with an NN upsampling block 404 (as shown in FIG. 4), which results in an initially upsampled point cloud PC₁ 406. PC₁ is inputted to a neural-network-based binary classifier 408, which determines the occupancy status 410 for each of the occupied voxels in PC₁. The initially upsampled point cloud PC₁ is pruned 412 by removing all the voxels that are classified as unoccupied (“0” in FIG. 4). The refined, upsampled PC₂ 414 is the output. See FIG. 21 for an example of pruning.

This approach resolves the two aforementioned shortcomings of the NN upsampling method of FIG. 3. However, in many applications, the success of the binary classifier is critical for this method to be an accurate geometric refinement. In accordance with some embodiments, the present application improves the performance of binary classification by introducing additional voxel context information.

The feature information according to the approach in FIG. 4 is a high-level, abstract descriptor of the geometry generated by deep neural network. Such feature information may be, in some cases, too abstract and insufficient to perform an accurate classification. Contrarily, the context information introduced in this application may include local, per voxel, knowledge that may be helpful clues for the binary classification.

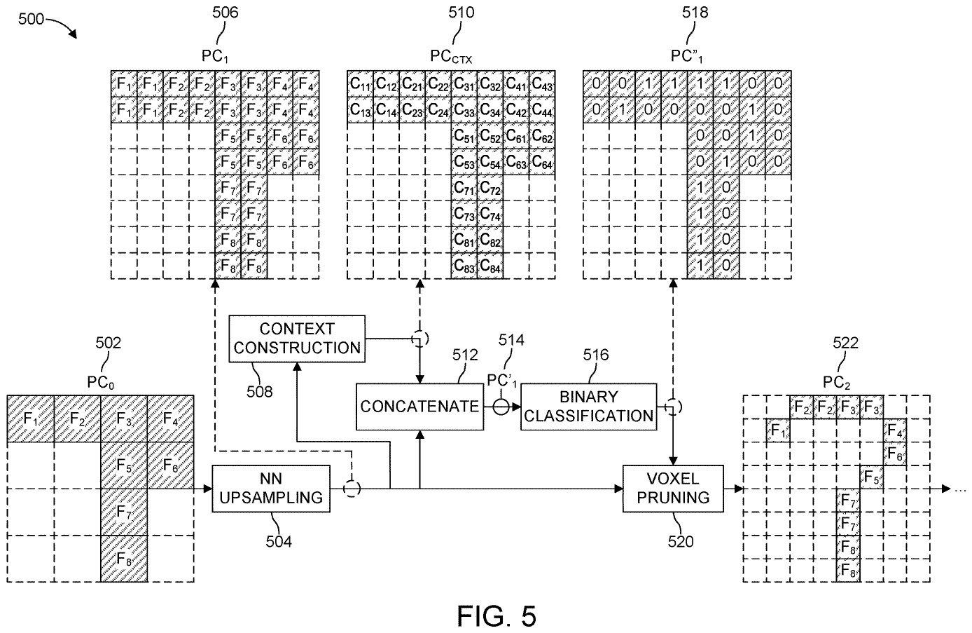

FIG. 5 is a schematic process diagram showing an example context-aware voxel-based upsampling with pruning according to some embodiments. The present application introduces a context point cloud that carries additional known information about the initially (“naively”) upsampled point cloud PC₁. By concatenating 512 (associating) the context point cloud 510 with the upsampled point cloud PC₁ 506, the subsequent binary classification 516 and voxel pruning 520 processes may better refine the initial upsampled point cloud PC₁ 506, which may lead to a more accurate upsampled point cloud, PC₂ 522. For some embodiments, a voxel pruning process 520 takes as inputs the upsampled point cloud PC₁ 506 and a binary-classified point cloud PC″₁ 518 to generate an output point cloud PC₂ 522. The block diagram of FIG. 5 shows a voxel-based upsampling method 500 for some embodiments. The voxel-based upsampling method performs classification 516 and pruning 520 to refine the upsampled geometry on top of the “naively” upsampled point cloud PC₁ (resulting from, e.g., NN upsampling 504 an input point cloud PC₀ 502). In FIG. 5, a context point cloud PC_{CTX} 510 is introduced that carries context information. The context construction block 508 takes the initial upsampled point cloud, PC₁ 506 as input and outputs the context point cloud, PC_{CTX} 510. A context point cloud PC_{CTX} 510 is concatenated with the “naively” upsampled point cloud PC₁ 506 to generate an augmented point cloud 514 as input to a binary classification stage 516. According to the example, the context point cloud PC_{CTX} 510 shares the same geometry as PC₁ 506, while PC_{CTX} 510 is intended to include context information (e.g., voxel-wise discriminative information) for predicting the ground-truth occupancy status (in this case for the voxels, whether a child voxel is “empty” or “occupied”). An augmented point cloud PC′₁ 514 is produced by concatenating 512 the features from PC_{CTX} 510 and PC₁ 506.

Concatenation is a commonly used operator in deep neural networks. The concatenation operator concatenates (all) the features in PC_{CTX} and the corresponding features in PC₁ to generate the augmented point cloud PC′₁. If an occupied voxel (x, y, z) in PC_{CTX} has an associated context information vector c of length a, while the same location (x, y, z) in PC₁ has an associated feature vector f₁ of length b, then the concatenation operator will concatenate c and f₁ together and generate another feature vector [c f₁] of length (a+b). This generated feature vector [c f₁] will be assigned to the voxel location (x, y, z) of the augmented point cloud PC′₁. This step may be performed for all occupied voxels in PC_{CTX} and PC₁ to generate augmented point cloud PC′₁. The augmented point cloud PC′₁ replaces PC₁ as the input to the binary classifier.

In accordance with some embodiments, context information may be any known knowledge or known context about a voxel. For example, context information may be the position of the voxel, such as [x, y, z] coordinates. Context information may include, for example, a bit-depth of an input point cloud. Context information may be other information, for example, such as the relative position of a voxel with respect to the parent voxel. Context is not limited to position information, however, and may include other types of information in addition to, or instead of, position information in some embodiments. In some embodiments, context information (e.g., voxel-wise discriminative information) may be used for predicting the ground-truth occupancy status of a voxel (e.g., whether a voxel is “empty” or “occupied”) because the context information may provide some information already known about the voxel. By incorporating such known context information, a deep neural network may better infer occupancy status.

For some embodiments, the context information comes from the processing of an input point cloud. The context information may be any information about the voxel and may be determined even before encoding the voxel. For instance, suppose the position [x,y,z] of a voxel and the current bit-depth of the voxel for the [x, y, z] information are known. As such, the context information may be expressed in spherical coordinates. See equations 1, 2, and 3 below.

The context information PC_{CTX} comes from the input point cloud PC₀. There is no other external source of the context information, in accordance with some embodiments. For example, the context information may be the (x, y, z) location coordinates. A context information vector c=[x y z] may be directly assigned to the voxel location (x, y, z) in PC_{CTX}. For some embodiments, this (x, y, z) coordinate location may be preprocessed and converted to another coordinate system, such as through Eqns. 1 to 3 as described below, and assigned to the voxel location (x, y, z) in PC_{CTX}.

In some embodiments, context information includes the x, y, and z coordinates. For example, for an occupied voxel (x, y, z) in PC_{CTX}, the context information may be the vector c=[x y z]. For some embodiments, normalized coordinates are used as context information. Suppose PC₁ has a bit-depth of N, which means that PC₁ has the dimensions 2^{N}×2^{N}×2^{N}. As such, the context information vector associated with the voxel (x, y, z) in PC_{CTX} may be

$$c = [ \begin{matrix}\frac{x}{{2}^{N}} & \frac{y}{{2}^{N}} & \frac{z}{{2}^{N}}\end{matrix} ] .$$

Moreover, instead of working with Euclidean coordinates, spherical coordinates may be used, which are particularly useful for processing LiDAR sweeps. To do so, Eqns. 1, 2, and 3 are applied, which are:

r=\sqrt{(x−2^{N-1})²+(y−2^{N-1})²+(z−2^{N-1})²} Eq. 1

$$ϕ = arccos ( \frac{y - {2}^{N - 1}}{r} ) \qquad Eq . 2$$

$$θ = arctan ( \frac{y - {2}^{N - 1}}{x - {2}^{N - 1}} ) \qquad Eq . 3$$

where N is the bit depth, r is the radial distance, φ is the elevation angle, and θ is the azimuth angle. The vector c becomes

$$c = [ \begin{matrix}r & φ & θ\end{matrix} ] , or c = [ \begin{matrix}\frac{r}{{2}^{N}} & φ & θ\end{matrix} ]$$

if the distance is normalized. In some embodiments, the context information may also be the bit-depth of PC₁, which is N. In this case, the feature is a constant scalar c=N. Moreover, instead of working with Euclidean coordinates or spherical coordinates, cylindrical coordinates may be used because cylindrical coordinates may be used for processing LiDAR sweeps. To do so, Eqns. 1 and 3 are applied to compute the radial distance (r) and the azimuth angle (θ), respectively. The Euclidian coordinates of the voxel (x, y, z) converted into cylindrical coordinates would be (r, θ, z). Thus, the vector c holding the context information becomes

$$c = [ \begin{matrix}r & θ & z\end{matrix} ] , or c = [ \begin{matrix}\frac{r}{{2}^{N}} & θ & \frac{z}{{2}^{N}}\end{matrix} ]$$

if the distance is normalized. Providing context information in different ways may ease the job of the binary classification process. For example, in some cases, if the height, z, is particularly relevant to the occupancy status of the voxel, then including the height z may help with classification. Another example is a LiDAR point cloud, in which case the height is in a reasonable range, e.g., the height is greater than zero because LiDAR is unable to sense something under underground. And in some embodiments, if the azimuth angle θ (Eq. 3), may be very relevant to the occupancy, then including the azimuth angle may help with the classification.

For some embodiments, an encoder may operate in the reverse direction of what is shown in FIG. 5. For example, an encoder may obtain a first point cloud, such as the pruned point cloud 522. The voxel occupancy status of the point cloud may be determined. A second point cloud may be generated by removing from the first point cloud the voxels determined to be empty. Features of the second point cloud may be determined and associated with context information to generate a third point cloud. For some embodiments, the features of the second point cloud may be concatenated with the context information. The third point cloud may be downsampled to obtain a fourth point cloud. The fourth point cloud may be outputted as the encoder output.

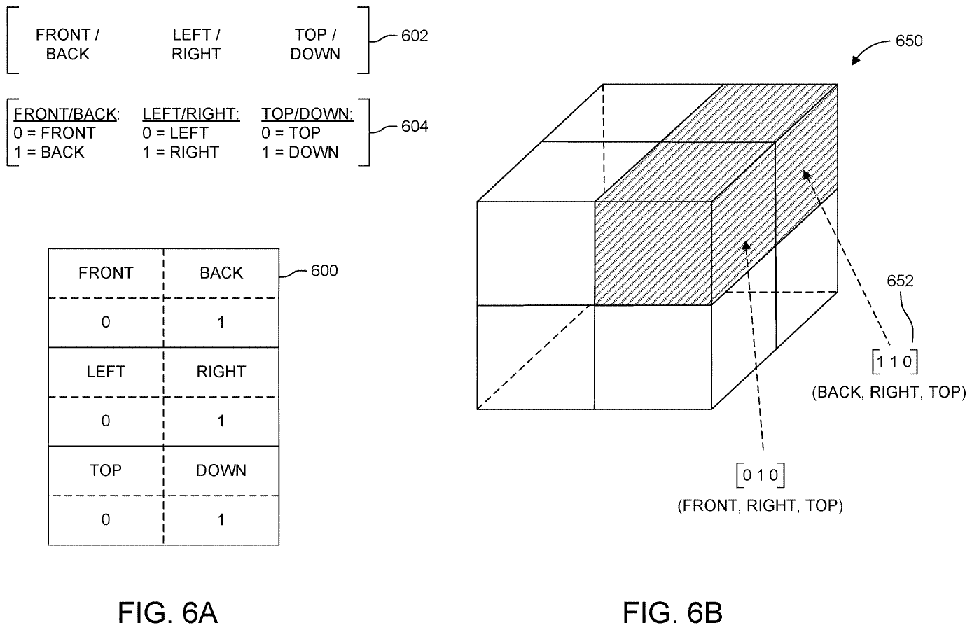

FIG. 6A is a table illustrating example position values according to some embodiments. In some embodiments, context information may be positions of a child voxel with respect to its parent voxel. For example, “front”/“back”, “left”/“right”, and “top”/“down” may be represented as “0” and “1”, respectively, as shown in the tables 600, 602, 604 of FIG. 6A. In other words, the left-most value of the feature array indicates front/back status, the center value indicates left/right status, and the right-most value indicates top/down status. A zero for front/back status indicates front, while a one for front/back status indicates back. A zero for left/right status indicates left, while a one for left/right status indicates right. A zero for top/down status indicates top, while a one for top/down status indicates down.

FIG. 6B is a schematic perspective view illustrating example child voxel positions as context information according to some embodiments. A child voxel of PC₁ located at the front, right, and top of its parent voxel 650 would have a 3-bit context information c=[0 1 0], while a child voxel of PC₁ 650 located at the back, right, and top of its parent voxel would have a 3-bit context feature 652 c=[1 1 0], as shown in FIG. 6B. In some embodiments, the 3-bit context feature vector may be interpreted as a binary number and converted to a decimal number, e.g., c=[0 1 0] becomes a scalar c=2 and c=[1 1 0] becomes a scalar c=6. In some embodiments, the context information may be any portion, combination, and/or permutation of the aforementioned example context features.

Returning to FIG. 5, consider the following example regarding the feature f₁ at the top-left corner of PC₀. This example will follow f₁ from the input point cloud PC₀ to the augmented point cloud PC′₁ prior to the binary classification block.

The feature f₁ and the other features f₂, f₃, . . . , f₈ of PC₀ are each 1-dimensional vectors. For this non-limiting example, the vector length will be 5. As such, each feature vector f₁, f₂, . . . , f₈ will be a 1×5 vector with 5 numbers. These feature vectors contain information about the ground-truth occupancy status of PC₂ and therefore are called geometric features. For example, f₁ contains information about ground-truth occupancy status of PC₂ in the top-left corner; while f₄ contains information about ground-truth occupancy of PC₂ in the top-right corner.

In this example, f₁, f₂, . . . , f₈ are abstract, high-level features/descriptors generated by deep neural networks. For this example, the values of f₁, f₂, . . . , f₈ do not have a concrete physical meaning and therefore are abstract and “high-level.” However, these values provide meaning to the neural network itself to perform inferences. Suppose these vector features are random numbers, such as:
f₁=[2.1 0.3 1.23 4.5 0.1],
   which are selected to show the movement of f₁.

As part of PC₀, f₁ is passed through the NN upsampling block, which creates 4 copies of f₁ at the top-left corner of PC₁, as shown in FIG. 5. PC₁ is passed to the context construction block, which creates four context information vectors corresponding to f₁ at the top-left corner of PC_{CTX}. These four corresponding context information vectors are c₁₁, c₁₂, c₁₃, and c₁₄. Suppose the context construction block uses the coordinates (x, y, z) (or only (x, y) in the 2D example of FIG. 5) of the voxels to build the context information vectors, then
c₁=[0 0],
c₂=[1 0],
c₁₃=[0 1],
c₁₄=[1 1],

PC_{CTX} and PC₁ are inputted into the concatenation block, leading to the point cloud

$${PC}_{1}^{′} .$$

For some embodiments, the concatenation block may perform the following example concatenations.
c₁₁ is concatenated with f₁, leading to a new vector:
   [c₁₁ f₁]=[0 0 2.1 0.3 1.23 4.5 0.1],
which is a voxel in the top-left corner (first row, first column) of PC′₁.
c₁₂ is concatenated with f₁, leading to a new vector:
   [c₁₂ f₁]=[1 0 2.1 0.3 1.23 4.5 0.1],
which is a voxel in the first row, second column of PC′₁.
c₁₃ is concatenated with f₁, leading to a new vector:
   [c₁₃ f₁]=[0 1 2.1 0.3 1.23 4.5 0.1],
which is a voxel in the second row, first column of PC′₁.
c₁₄ is concatenated with f₁, leading to a new vector:
   [c₁₄ f₁]=[1 1 2.1 0.3 1.23 4.5 0.1],
which is a voxel in the second row, second column of PC′₁.
   The obtained point cloud,

$${PC}_{1}^{′} ,$$

is inputted into the binary classification block to determine whether or not an allegedly-occupied voxel in

$${PC}_{1}^{′}$$

is actually occupied according to the determined ground truth point cloud,

$${PC}_{1}^{″} .$$

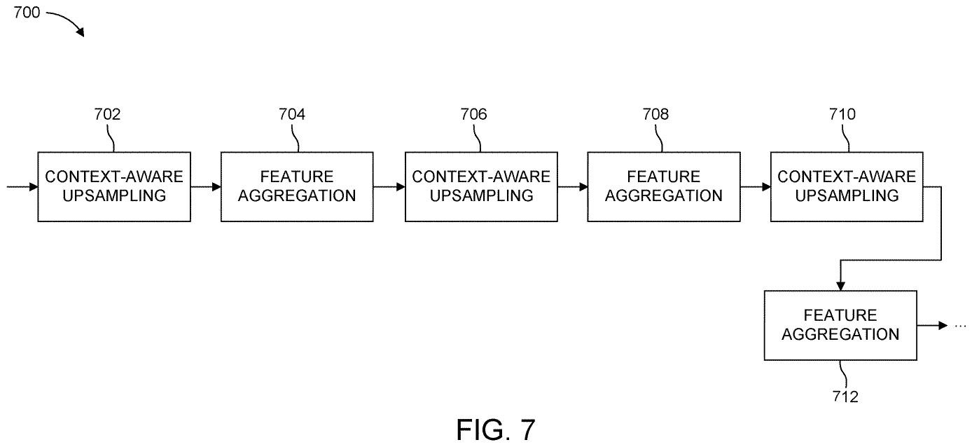

FIG. 7 is a flowchart illustrating an example process for cascading several context-aware upsamplings according to some embodiments. In some embodiments of an example process 700, context-aware voxel-based upsampling 702, 706, 710 may be cascaded multiple times to achieve higher upsampling ratios, as shown in FIG. 7. In this case, in between two consecutive upsamplings 702, 706, 710, feature aggregation blocks 704, 708, 712 may be inserted for refinement and feature aggregation. For example, a feature aggregation block may take as input a sparse tensor with features having N channels. The feature aggregation block modifies the features to better serve the compression task. Particularly, to obtain high-quality reconstructions for point cloud decompression, the feature aggregation block generates descriptive or distinctive geometric features that are capable of representing local geometric details. The output features still have N channels, which means that the feature aggregation block does not change the shape of the sparse tensor. For some embodiments, feature aggregation may be, for example, a cascaded sparse convolutional layers architecture, a residual network (ResNet) architecture, an Inception-ResNet (IRN) architecture, or a transformer block. For some embodiments, context-aware upsampling may be performed by the process shown in FIG. 5.

For some embodiments, the feature aggregation blocks shown in FIG. 7 may include a weight sharing mechanism. In FIG. 7, multiple context-aware blocks are cascaded (in series). The feature aggregation blocks and the context-aware upsampling blocks of FIG. 7 may share the same set of neural network parameters for some embodiments.

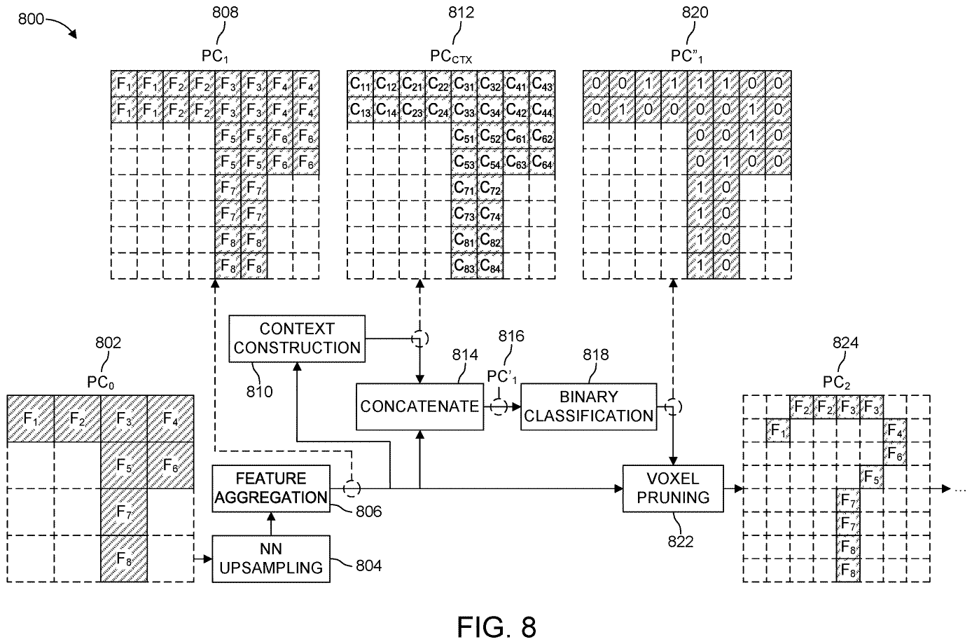

FIG. 8 is a schematic process diagram showing an example context-aware voxel-based upsampling with initial feature aggregation according to some embodiments. In some embodiments, a feature aggregation block 806 may be inserted right after the NN upsampling block 804 for initial feature refinement, as shown in FIG. 8. The features of PC₀ 802 are carried over to the features of PC₁ 808 based on the NN upsampling 804 allocation. Furthermore, a concatenation block 814 is inserted prior to the binary classification block 818, similar to what is shown in FIG. 5. For some embodiments, the blocks of FIG. 8 operate the same as the blocks described in FIG. 5 with the addition of a feature aggregation block.

As in FIG. 5, the context construction block 810 takes the initial upsampled point cloud, PC₁ 808 as input and outputs the context point cloud, PC_{CTX} 812. By concatenating 814 the context point cloud 812 with the upsampled point cloud PC₁ 808, the subsequent binary classification 818 and voxel pruning 822 processes may refine the initial upsampled point cloud PC₁ 808, which may lead to a more accurate upsampled point cloud, PC₂ 824. An augmented point cloud PC′₁ 816 is produced by concatenating 814 the features from PC_{CTX} 812 and PC₁ 808. For some embodiments of an example process 800, a voxel pruning process 822 takes as inputs the upsampled point cloud PC₁ 808 and a binary-classified point cloud PC″₁ 820 and generates an output point cloud PC₂ 824.

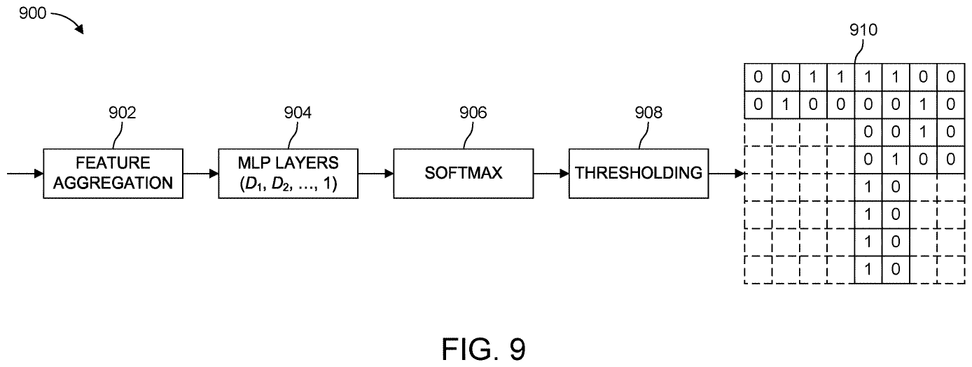

FIG. 9 is a flowchart illustrating an example process for binary classification according to some embodiments. FIG. 9 may be considered as a way to perform binary classification with a neural network. A binary classifier may be used to predict the ground-truth occupancy status for each occupied voxel in an input point cloud (PC₁). A binary classifier classifies each occupied voxel in PC₁ with a 1 (occupied) or a 0 (empty) so that the geometry of PC₁ may be refined. For some embodiments, the binary classification process 900 of FIG. 9 may be used for the binary classification blocks of FIGS. 5 and 8.

In FIG. 9, the concatenated point cloud PC′₁ is inputted into a feature aggregation block for feature refinement and extraction, with an output channel size of D₁. An input point cloud undergoes feature aggregation 902. The aggregated feature is then inputted into the multi-layer perceptron (MLP) layers 904 with channel dimensions (D₁, D₂, . . . , 1) for classification. An MLP layer is a neural network layer which applies a linear mapping to an input feature vector. For instance, to map an input feature of length D₁ to an output feature of length D₂, an MLP layer multiplies a matrix of size D₁×D₂ by the input feature, leading to an output feature of length D₂. When cascading two MLP layers, a non-linear activation function (such as a ReLU function) is inserted in-between the two MLP layers. The outputs are inputted into a softmax function 906, which converts the MLP output values to the range of 0 to 1. For values above 0.5 up to 1, a thresholding block 908 converts the value to a 1 to indicate an occupied status. For values in the range 0 to 0.5, the thresholding block converts the value to a 0 to indicate an empty status as reflected in the binary-classified output 910.

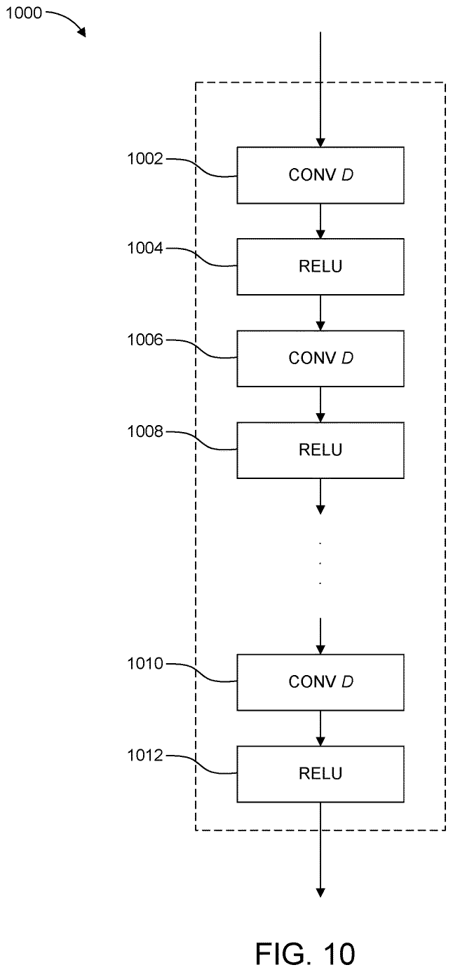

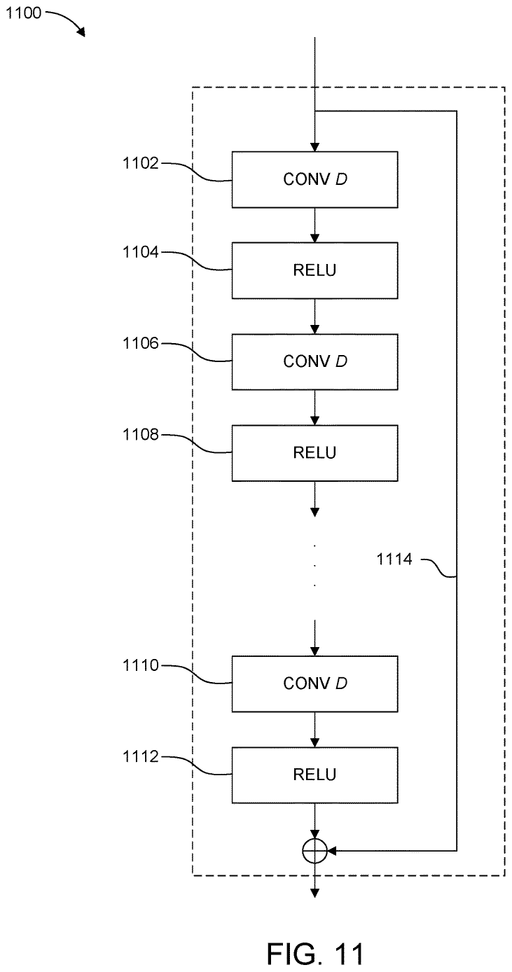

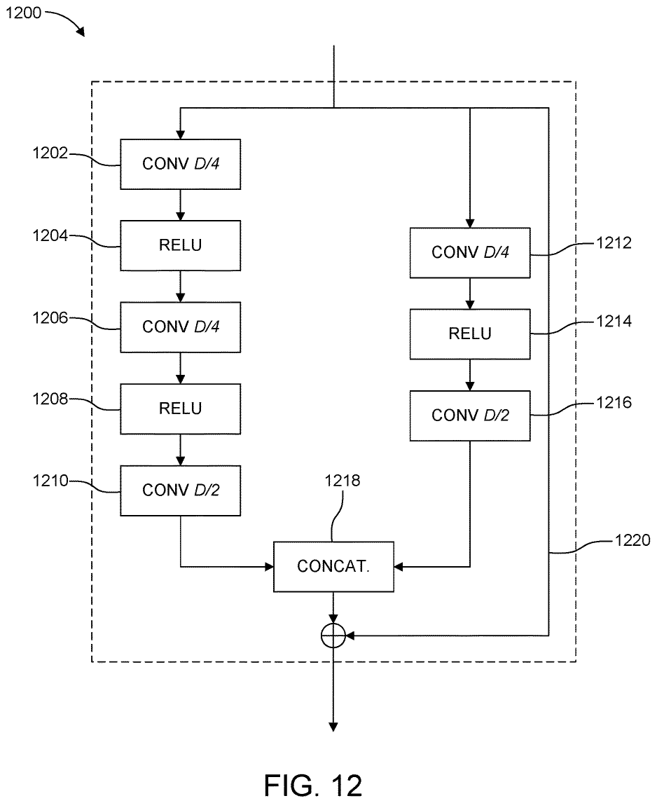

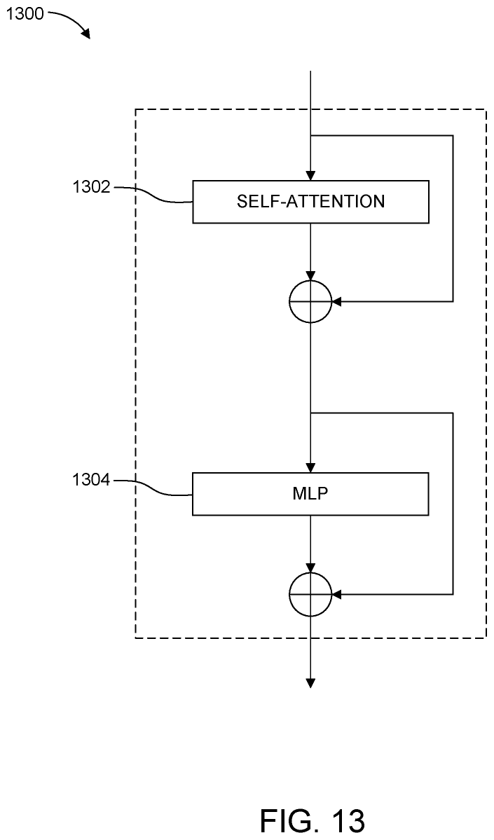

FIGS. 10-13 show four different design choices for feature aggregation for some embodiments. For example, in some embodiments, a feature aggregation block may be a cascaded sparse convolutional layers architecture 1000 (e.g., FIG. 10), a residual network (ResNet) architecture 1100 (e.g., FIG. 11), an Inception-ResNet (IRN) architecture 1200 (e.g., FIG. 12), or a transformer block architecture 1300 (e.g., FIG. 13).

FIG. 10 is a block diagram illustrating an example process with cascaded sparse convolutional layers for feature aggregation according to some embodiments. For some embodiments, such as the example shown in FIG. 10, two blocks are repeated multiple times to form a series. The two blocks are a sparse 3D convolution layer 1002, 1006, 1010 (“CONV D”) followed by a ReLU activation 1004, 1008, 1012 (“ReLU”). For the example shown in FIG. 10, “CONV D” denotes a sparse 3D convolution layer with D output channels. A “ReLU” activation refers to a rectifier linear unit activation function. For example, the ReLU activation block may output 0 for negative input values and may output the input multiplied by a scalar value for positive input values. In another embodiment, the ReLU activation function may be replaced by other activation functions, such as a tan h( ) activation function and/or a sigmoid( ) activation function. For some embodiments, a nonlinear activation process may include a rectifier linear unit (ReLU) activation process.

FIG. 11 is a block diagram illustrating an example ResNet block for feature aggregation according to some embodiments. In some embodiments, a feature aggregation process may use a ResNet architecture, as shown in FIG. 11. The article He, Kaiming, et al., Deep Residual Learning for Image Recognition, PROCEEDINGS OF THE IEEE CONF. ON COMPUTER VISION AND PATTERN RECOGNITION 770-778, IEEE (2016) (“He”) describes an example ResNet architecture. See, for example, the right-most process line of FIG. 3 on page 4 of He.

The example in FIG. 11 shows a ResNet block architecture to aggregate features with D channels. For some embodiments, such as the example shown in FIG. 11, two blocks are repeated multiple times to form a series. The two blocks are a sparse 3D convolution layer 1102, 1106, 1110 (“CONV D”) followed by a ReLU activation 1104, 1108, 1112 (“ReLU”). Compared to FIG. 10, FIG. 11 introduces a residual connection 1114 to the input to add the input with the output of the series of convolutional layers.

FIG. 12 is a block diagram illustrating an example Inception-ResNet block for feature aggregation according to some embodiments. For some embodiments, feature aggregation may be structured with an Inception-ResNet (IRN) architecture, as shown in FIG. 12. FIG. 1(b) of Wang also shows an IRN architecture. The example of FIG. 12 shows the architecture of an IRN block to aggregate features with D channels. The IRN block separates the feature aggregation process into three parallel paths.

The path with more convolutional layers (the left path in FIG. 12) aggregates (more) global information with a larger receptive field. For some embodiments, the left path may include a convolution layer 1202, followed by two sets of a ReLU activation 1204, 1208 and a convolution layer 1206, 1210.

The path with less convolutional layers (the middle path in FIG. 12) aggregates local detailed information with a smaller receptive field. For some embodiments, the middle path may include a convolution layer 1212, followed by a ReLU activation 1214 and a convolution layer 1216.

The last path 1220 (the right path in FIG. 12) is a residual connection which brings the input directly to the output similar to the residual connection in FIG. 11. For some embodiments, a ReLU block may be inserted after the CONV D/2 block and prior to the concatenation 1218 on each of the left and middle paths of FIG. 12.

FIG. 13 is a block diagram illustrating an example transformer block for feature aggregation according to some embodiments. Section 3.2 of the article Mao, Jiageng, et al., Voxel Transformer for 3D Object Detection, PROCEEDINGS OF THE IEEE/CVF INTERNATIONAL CONFERENCE ON COMPUTER VISION 3164-3173, IEEE (2021) (“Mao”) discusses a voxel transformer. For some embodiments, a transformer architecture for the present application may be similar to a voxel transformer of Mao.

The diagram of a transformer block is shown in FIG. 13. The output of a self-attention block 1302 is added to the input to the self-attention block via a residual connection. Connected in series with the result of that addition is an MLP block 1304 in which the output of the MLP block 1304 is added to the input to the MLP block 1304 via another residual connection. An MLP block includes a series of multi-layer perceptron (MLP) layers.

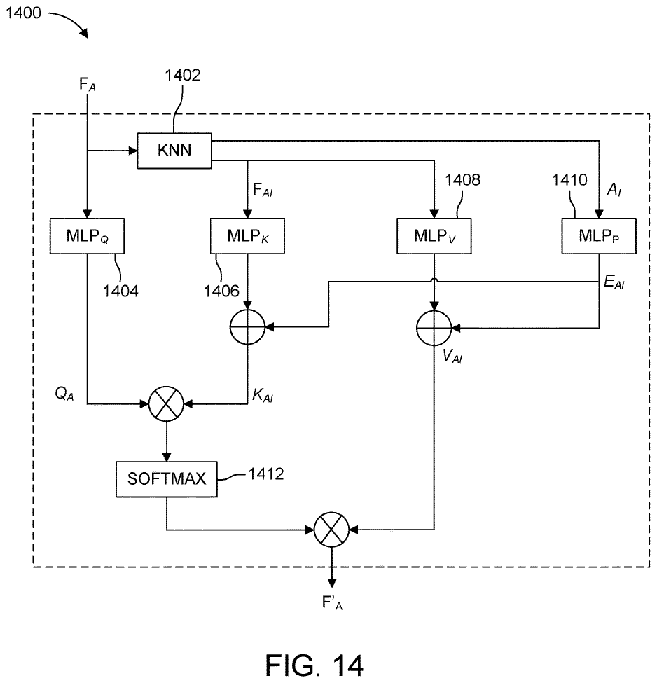

FIG. 14 is a block diagram illustrating an example architecture of a self-attention block according to some embodiments. For some embodiments, the self-attention block 1302 of FIG. 13 may be implemented using the architecture 1400 described in FIG. 14. Given a current feature vector f_{A} associated with a voxel location A and its neighboring k features f_{A}_{ᵢ} associated with voxel locations Aᵢ, in which Aᵢ for (0≤i≤(k−1)) are the k nearest neighbors of A in the input sparse tensor, the self-attention block 1400 endeavors to update the feature f_{A} based on all the neighboring features f_{A}_{ᵢ}. The points Aᵢ are obtained by a k nearest neighbor (kNN) search 1402 based on the coordinates of A. The query 1404 embedding Q_{A} for A is computed by Eq. 4:

Q_{A}=MLP_{Q}(f_{A}) Eq. 4

where MLP_{Q}(⋅) 1404 represents MLP layers to obtain the query. E_{A}_{ᵢ} is the positional encoding 1410 between the voxels A and Aᵢ, which is calculated by Eq. 5:

E_{A}_{ᵢ}=MLP_{P}(P_{A}−P_{A}_{ᵢ}) Eq. 5

where MLP_{P}(⋅) 1410 represents MLP layers used to obtain the positional encoding. P_{A} and P_{A}_{ᵢ} are the 3D coordinates for the centers of voxels A and Aᵢ, respectively. The key embedding K_{A}_{ᵢ} and the value embedding V_{A}_{ᵢ} of all the nearest neighbors of A are computed using Eqns. 6 and 7:

K_{A}_{ᵢ}=MLP_{K}(f_{A}_{ᵢ})+E_{A}_{ᵢ},0≤i≤(k−1) Eq. 6

V_{A}_{ᵢ}=MLP_{V}(f_{A}_{ᵢ})+E_{A}_{ᵢ},0≤i≤(k−1) Eq. 7

where MLP_{K}(⋅) 1406 and MLP_{V}(⋅) 1408 are MLP layers to obtain the key and value, respectively. The self-attention block outputs the output feature

$${f}_{A}^{′}$$

of location A as given by Eq. 8, which is:

$${f}_{A}^{′} = {\sum }_{i = 0}^{k - 1} σ ( \frac{{Q}_{A}^{T} \cdot {K}_{{A}_{i}}}{c \sqrt{d}} ) \cdot {V}_{{A}_{i}} \qquad Eq . 8$$

where σ(⋅) is the softmax normalization function 1412, d is the length of the feature vector f_{A}, and c is a pre-defined constant.

Eqns. 4 to 8 are shown in FIG. 14. Eq. 4 is shown in the upper left of FIG. 14, in which the MLP_{Q}(⋅) block 1404 takes the current feature vector f_{A} as an input and outputs Q_{A}. At the top of FIG. 14, the kNN block 1402 takes the current feature vector f_{A} as an input and performs a k nearest neighbor (kNN) search based on the coordinates of A. The outputs of the kNN block 1402 are the coordinates of Aᵢ for 0≤i≤(k−1). Eq. 5 is shown in the upper right corner of FIG. 14 in which the MLP_{P}(⋅) block 1410 takes as an input the difference between the voxels A and Aᵢ and outputs E_{A}_{ᵢ} Eq. 6 is shown in the left center portion of FIG. 14, in which the feature vector f_{A}_{ᵢ} is the input into the MLP_{K}(⋅) block 1406, and the output of the MLP_{K}(⋅) block 1406 is added to E_{A}_{ᵢ} to generate K_{A}_{ᵢ} for 0≤i≤(k−1). Eq. 7 is shown in the right center portion of FIG. 14, in which the feature vector f_{A}_{ᵢ} is the input into the MLP_{V}(⋅) block 1408, and the output of the MLP_{V}(⋅) block 1408 is added to E_{A}_{ᵢ} to generate V_{A}_{ᵢ} for 0≤i≤(k−1). Applying Eq. 8 to FIG. 14, the input to the softmax normalization function 1412 is the dot-product of

$${Q}_{A}^{T}$$

and K_{A}_{ᵢ}. This dot product is divided by c\sqrt{d} to normalize by the length of the feature vector f_{A}. The output feature

$$( {f}_{A}^{′} )$$

for location A, which is shown at the bottom of FIG. 14, is the summation of the k nearest neighbors for the dot product of the softmax function output and V_{A}_{ᵢ}.

In some embodiment, instead of using a kNN search, which searches for k points in a point cloud that are closest to point A, all of the points in the point cloud that are within a distance r from A may be used. This operation is called a ball query. The value (or radius) r for ball query may be determined by the quantization step size s of the quantizer. For instance, given a larger s, which corresponds to a coarser point cloud, the value of r becomes larger so as to cover more points from the original point cloud

In some embodiments, a kNN search may be used to look for k points that are closest to a query point, say A. However, after that, only the points that are within a distance r from A are kept. The value of r may be determined in the same way as the ball query. The distance metric used by the kNN search may be any distance metric.

In some embodiments, a transformer block (such as the example shown in FIG. 13) updates the feature for (all) the occupied locations in the sparse tensor in the same way and outputs the updated sparse tensor. For some embodiments, MLP_{Q}(⋅), MLP_{P}(⋅), MLP_{K}(⋅), and MLP_{V}(⋅) may contain only one fully-connected layer, which corresponds to linear projections.

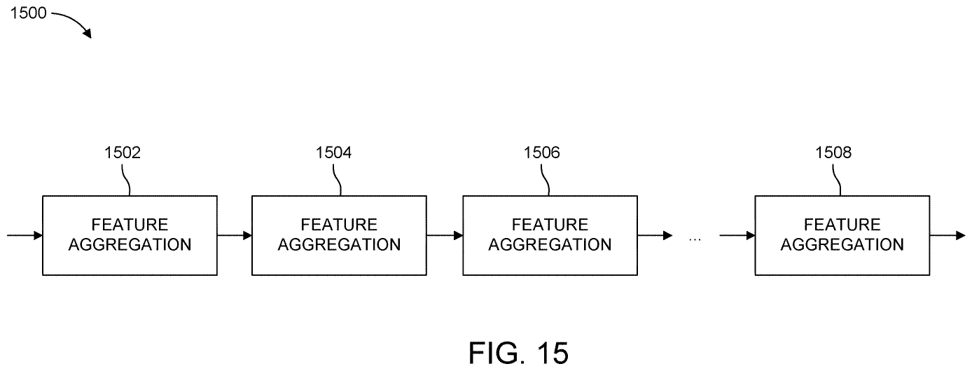

FIG. 15 is a flowchart illustrating an example process for cascading several feature aggregations according to some embodiments. For some embodiments, several feature aggregation blocks 1502, 1504, 1506, 1508 (such as the feature aggregation block examples shown in FIGS. 10 to 13) are cascaded together to further enhance the performance, as shown in the example process 1500 of FIG. 15. The feature aggregation blocks may be of the same type, e.g., all of them being transformer blocks.

In some embodiments where the feature aggregation blocks are of the same type, the parameters of their neural network layers are shared. By sharing the neural network parameters among the feature aggregation blocks, the total number of parameters of the neural network model may be reduced, which has (for example) the following two benefits. Firstly, the model size of the neural network may be reduced, which makes storage or transmission of the neural network model easier. Secondly, reducing the total number of parameters to be learned during the training stage may make the training converge faster. However, a consequence of sharing neural network parameters among the feature aggregation blocks may be a reduction in the capacity of the neural network model, which may make the neural network less capable of extracting high-level features, and may decrease the performance of the neural network. These potential consequences may prove disadvantageous for some applications.

For some embodiments, each aggregation block may use the same neural network with a separate set of neural network parameters. For some embodiments, each aggregation block may use separate neural networks with separate sets of neural network parameters. The separate sets of neural network parameters may be identical for some embodiments. For some embodiments, the first set of neural network parameters and the second set of neural network parameters are the same set of (identical) neural network parameters, and the same set of neural network parameters may be used by at least a first neural network and a second neural network. For some embodiments the first set of neural network parameters and the second set of neural network parameters are distinct but identical sets of neural network parameters.

Of course, in some embodiments, not all sets of neural network parameters are identical across all neural networks and not all neural networks are identically modeled across all functional blocks (e.g., feature aggregation blocks). In some embodiments with two or more feature aggregation blocks, two or more feature aggregation blocks including two or more respective neural networks may utilize two or more respective identical set of neural network parameters.

In some embodiments, the feature aggregation blocks may be a mixture of different types of feature aggregation blocks, e.g., a mixture of IRN blocks and transformer blocks. For some embodiments, a single feature aggregation block may be replaced by two or more feature cascaded aggregation blocks to achieve better compression performance.

Context-aware, voxel-based upsampling may be applied to point cloud decompression. In some embodiments, context-aware, voxel-based upsampling may be applied to the decoder of application '087 to generate point clouds closer to the ground truth.

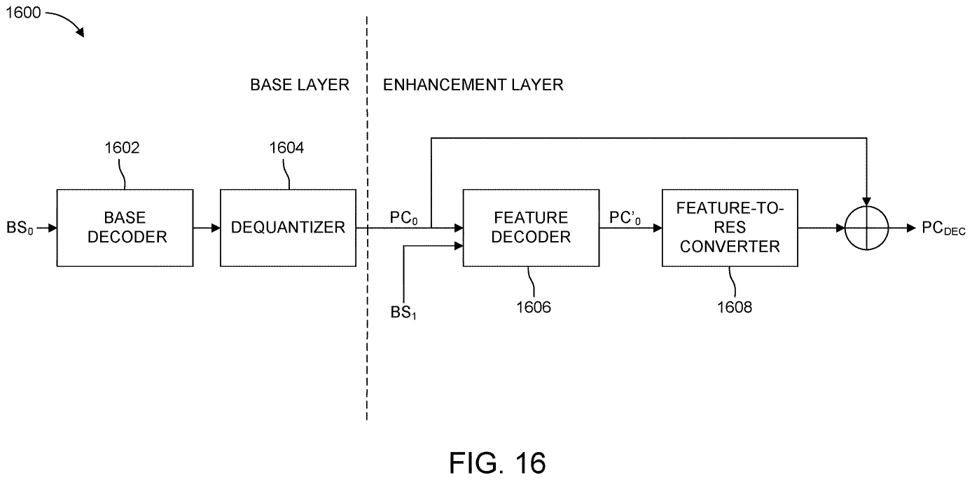

FIG. 16 is a block diagram illustrating an example original decoder architecture according to some embodiments. The architecture 1600 of the decoder of application '087 is shown in FIG. 16, which includes a base layer and an enhancement layer. The base layer receives a bitstream BS₀, which is used to perform a base decode 1602 and dequantization 1604 and generate a coarse/simplified point cloud PC₀. PC₀ is a simplified or low-resolution version of the original input point cloud in voxel-based representation. From the bitstream BS₁, the feature decoder block 1606 decodes the voxel-wise features of PC₀, which equips every occupied voxel in PC₀ with a vector feature which is an abstraction of the local geometry. If BS₁ is not available, which is called a “skip mode” in application '087, the feature decoder still synthesizes, for each voxel in PC₀, a vector feature based on the geometry of PC₀. The resulting features attached to the point cloud are denoted as PC′₀. In application '087, every feature in PC′₀ is inputted to a feature-to-residual converter 1608 to decode a set of local 3D points. Specifically, for a voxel A in PC′₀ located at (x_{A}, y_{A}, z_{A}), its feature f_{A} is inputted to the feature-to-residual converter, which outputs k sets of 3D points

$$\{ ( {x}_{0}^{′} , {y}_{0}^{′} , {z}_{0}^{′} ) , ( {x}_{1}^{′} , {y}_{1}^{′} , {z}_{1}^{′} ) , … , ( {x}_{k - 1}^{′} , {y}_{k - 1}^{′} , {z}_{k - 1}^{′} ) \} .$$

The feature-to-residual converter 1608 may be a series of MLP layers. A geometric summation (“⊕” in FIG. 16) translates the decoded point set by translating them with (x, y, z) as shown in Eqns. 9-11:

$${x}_{i}^{′} = {x}_{i} + {x}_{A} , i = 0 , 1 , … , k - 1 \qquad Eq . 9$$

$${y}_{i}^{′} = {y}_{i} + {y}_{A} , i = 0 , 1 , … , k - 1 \qquad Eq . 10$$

$${z}_{i}^{′} = {z}_{i} + {z}_{A} , i = 0 … , k - 1 \qquad Eq . 11$$

The translated point set

$$\{ ( {x}_{0}^{′} , {y}_{0}^{′} , {z}_{0}^{′} ) , ( {x}_{1}^{′} , {y}_{1}^{′} , {z}_{1}^{′} ) , … , ( {x}_{k - 1}^{′} , {y}_{k - 1}^{′} , {z}_{k - 1}^{′} ) \}$$

associated with every voxel in the feature set PC′₀ forms the decoded point cloud PC_{DEC}. If there are M voxels in PC′₀, the decoded point cloud PC_{DEC} contains Mk points.

In the base layer of FIG. 16, a point cloud is decoded from bitstream BS₀ with the base decoder. A dequantizer is applied to the point cloud to obtain the coarser point cloud PC₀. For some embodiments, the dequantizer may use a step size of s.

In the enhancement layer, a feature decoder is applied to decode BS₁ with the already decoded coarser point cloud PC₀ to output a set of pointwise features PC′₀. The feature set PC′₀ contains the pointwise features for each point in PC₀. For instance, a point A in PC₀ has its own feature vector f′_{A}. The decoded feature vector f′_{A} may have a different size from f_{A}, its corresponding feature vector on the encoder side. However, both f_{A} and f′_{A} are generated to describe the local fine geometry details of PC₀ that are close to point A. The decoded feature set PC′₀ is inputted into a feature-to-residual converter, which generates the residual component of PC_{DEC}. The coarser point cloud PC₀ and the residual are inputted into a geometric summation block. The summation block adds the residual component to the coarser point cloud PC₀ to generate the final decoded point cloud PC_{DEC}.

For some embodiments, the base decoder may be any PCC codec. In some embodiments, the base decoder is chosen to use a lossy PCC codec, such as a codec in Wang. In some embodiments, the base codec may be a lossless PCC codec, such as the MPEG G-PCC standard, or deep entropy models with an octree representation.

The number of decoded points m may be a fixed constant, such as m=5, or the number of decoded points may be adaptively chosen, such as based on the prior knowledge about the density level of the original point cloud. For instance, if the original point cloud is very sparse, m may be set to be a small number, such as m=2.

The feature-to-residual converter converts the decoded feature set PC′₀ back to a residual component of PC_{DEC}. Specifically, for some embodiments, the feature-to-residual converter applies a deep neural network to convert every feature vector f′_{A} (associated with a point A in PC₀) in PC′₀ back to a corresponding residual point set S′_{A}.

In some embodiment, the feature-to-residual converter may be a series of MLP layers. In this case, a feature vector in PC′₀, say f′_{A}, is inputted to a series of MLP layers. The MLP layers directly output a set of m 3D points C₀, C₁, . . . , Cₘ₋₁, which gives the decoded residual set SA. Hence, for PC₀ with n points A₀, A₁, . . . , Aₙ₋₁, the feature-to-residual converter generates respective decoded residual sets, denoted as S′₀, S′₁, . . . , S′ₙ₋₁. These residual sets together constitute the decoded residual component.

In some embodiments, those 3D points in the residual component that are too far away from the origin may be removed. Specifically, for a point Cᵢ in the residual component, if its distance to the origin is larger than a threshold t, the point C is viewed as an outlier and removed from the residual component. The threshold t may be a predefined constant. The threshold also may be chosen according to the quantization step size s of the quantizer on the encoder. For instance, a larger s means PC₀ is coarser, and the threshold may be set to a larger value in order to keep more nodes in the residual component.

The value of k may be chosen based on the density level of the input point cloud. For a dense point cloud, the value of k may be larger (e.g., k=10). For a sparse point cloud, such as a LiDAR sweep, the value of k may be very small, such as k=1, which may mean that every point in PC₀ of FIG. 16 is associated with only one point in the original point cloud.

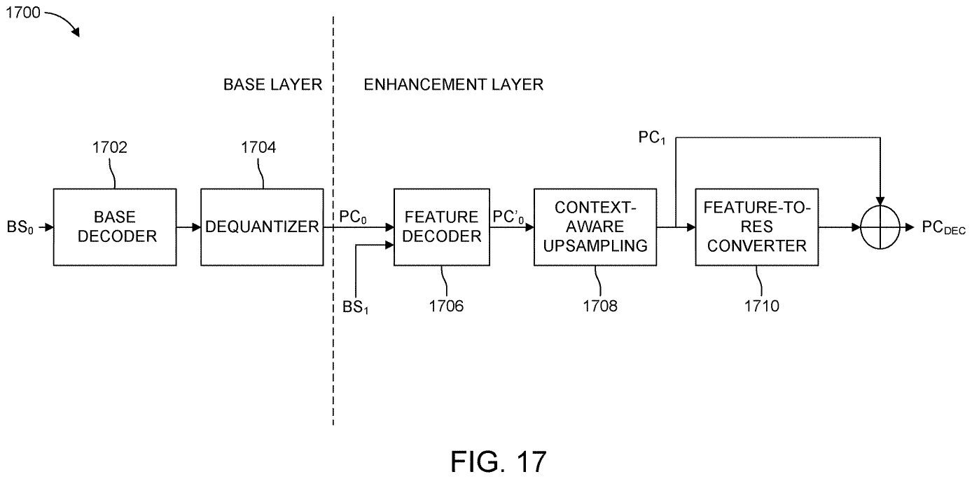

FIG. 17 is a block diagram illustrating an example decoder architecture with voxel-based upsampling according to some embodiments. For some embodiments, as shown in FIG. 16 and here in FIG. 17, the base layer receives a bitstream BS₀, which is used to perform a base decode 1702 and dequantization 1704. For some embodiments, as shown in FIG. 17, a context-aware upsampling block 1708 is inserted between the feature decoder block 1706 and the feature-to-residual converter 1710. Moreover, the geometric summation module now takes PC₁ as input instead of PC₀ shown in FIG. 16. In some embodiments, instead of encoding/decoding the original PC₀ in FIG. 16, now the PC₀ encoded/decoded in FIG. 17 becomes two-times smaller and thus less bits. For some embodiments, the context-aware upsampling block 1708 of FIG. 17 may be performed by the example context-aware voxel-based upsampling with pruning process shown in FIG. 5.

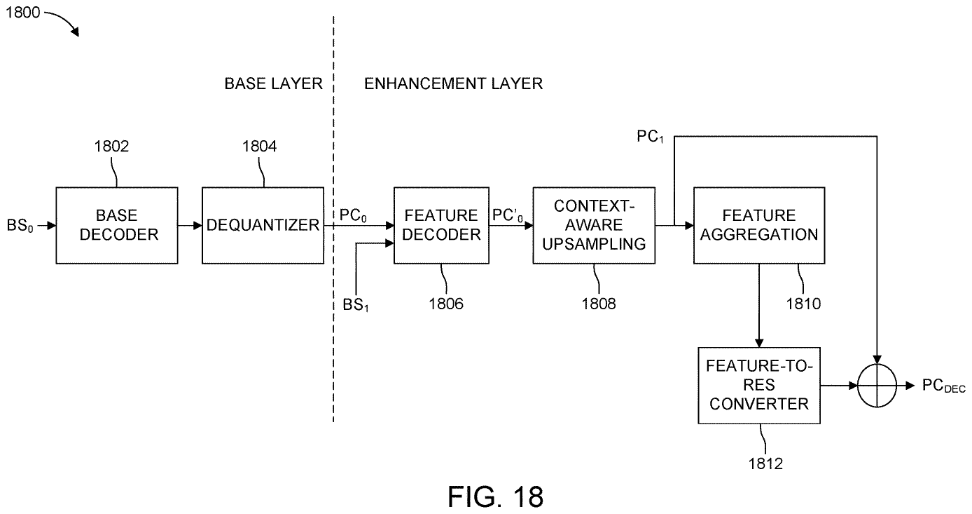

FIG. 18 is a block diagram illustrating an example decoder architecture with voxel-based upsampling and feature aggregation according to some embodiments. In some embodiments of an example process 1800, a feature aggregation block 1810 is inserted between the context-aware upsampling block 1808 and the feature-to-res converter 1812, as shown in FIG. 18. In this case, the context-aware upsampling block 1808 also may be cascaded multiple times, such as in the way presented in FIG. 7, to achieve higher upsampling ratios and extra bit-savings of PC₀. For some embodiments, the base layer receives a bitstream BS₀, which is used to perform a base decode 1802, dequantization 1804, and a feature decode 1806.

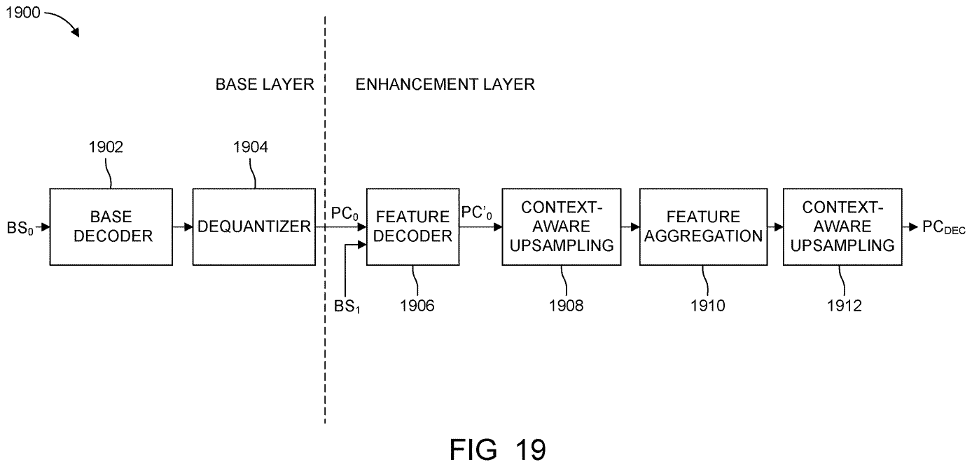

FIG. 19 is a block diagram illustrating an example decoder architecture without a feature-to-residual converter according to some embodiments. For some embodiments, compared to FIG. 18, only the context-aware upsampling blocks 1908, 1912 are presented, and the feature-to-res converter is removed, as shown in FIG. 19. In this scenario, PC₀ is gradually upsampled and refined to obtain the decoded point cloud PC_{DEC}. In the example of FIG. 18, two context-aware upsampling blocks 1908, 1912 are shown on either side of a feature aggregation block 1910. However, in some embodiments, a different number of context-aware upsampling blocks may be used to obtain PC_{DEC}. For some embodiments, the base layer receives a bitstream BS₀, which is used to perform a base decode 1902, dequantization 1904, and a feature decode 1906.

In the application '015, a hybrid coding framework for a PCC is used to implement an octree-based PCC, a voxel-based PCC, and a point-based PCC. For some embodiments, one or more of these types of PCCs may be used in the methods shown in FIGS. 17, 18, and 19. Application '015 proposes combining two of these types of PCCs. Particularly, in one case, only (i) octree-based PCC and (ii) voxel-based PCC methods are used. This configuration corresponds to FIG. 19.

The processes described in this application may be applied to point cloud super-resolution. For some embodiments, a context-aware upsampling process may be applied to an input point cloud PC₀ and a set of features associated with each of its occupied voxels to achieve a super-resolution of 2 times. In some embodiments, multiple context-aware upsampling processes may be applied to an input point cloud PC₀ and a set of features associated with each of its occupied voxels as shown in FIG. 7 to achieve a super-resolution of more than 2 times.

For some embodiments, features associated with voxels may be attributes such as color and intensity. In some embodiments, features associated with voxels may be local geometric features of PC₀ extracted with neural network layers, such as the feature aggregation processes shown in FIGS. 10-12. In some embodiments, features associated with voxels may be the concatenation of both attributes and geometric features.

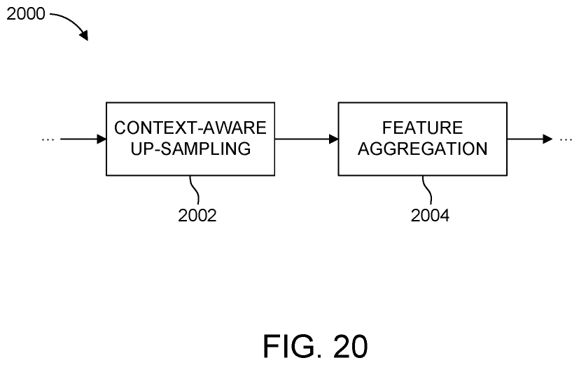

FIG. 20 is a block diagram illustrating an example decoder architecture with a single progression through voxel-based upsampling and feature aggregation according to some embodiments. In some embodiments of an example feature decoder process 2000, if context-aware voxel-based upsampling 2002 is applied only once, feature aggregation 2004 may be appended after the context-aware voxel-based upsampling for feature aggregation and refinement, as shown in FIG. 20.

If applying context-aware voxel-based upsampling followed by a feature aggregation (as shown in FIG. 20), the feature aggregation and all other feature aggregations within a context-aware upsampling block have the same neural network architecture and share the same neural network parameters. For some embodiments, by letting all the feature aggregation blocks share the same set of weights, the total number of neural networks parameters may be reduced. By sharing the neural network parameters among the feature aggregation blocks, the total number of parameters of the neural network model may be reduced, which has (for example) the following two benefits. Firstly, the model size of the neural network may be reduced, which makes storage or transmission of the neural network model easier. Secondly, reducing the total number of parameters to be learned during the training stage may make the training converge faster. However, a consequence of sharing neural network parameters among the feature aggregation blocks may be a reduction in the capacity of the neural network model, which may make the neural network less capable of extracting high-level features and may decrease performance of the neural network. These potential consequences may prove disadvantageous for some applications.

Of course, in some embodiments, not all sets of neural network parameters are identical across all neural networks and not all neural networks are identically modeled across all functional blocks (e.g., feature aggregation blocks). In some embodiments with two or more feature aggregation blocks, two or more feature aggregation blocks including two or more respective neural networks may utilize two or more respective identical set of neural network parameters.

For some embodiments, if context-aware voxel-based upsampling is used with pruning as shown in FIG. 5, then the following feature aggregation blocks may share the same set of neural network parameters: (i) a feature aggregation block within a binary classification block (which is shown in FIG. 9), and (ii) a feature aggregation block following a context-aware voxel-based upsampling block (which is shown in FIG. 20).

Similarly, for some embodiments, if context-aware voxel-based upsampling is used with initial feature aggregation as shown in FIG. 8, then the following feature aggregation blocks may share the same set of neural network parameters: (i) a feature aggregation block following a nearest-neighbor (NN) upsampling block (which is shown in FIG. 8), (ii) a feature aggregation block within a binary classification block (which is shown in FIG. 9), and (iii) a feature aggregation block following a context-aware voxel-based upsampling block (which is shown in FIG. 20).

FIG. 21 is a block diagram illustrating example sparse tensor operations according to some embodiments. FIG. 21 is used to illustrate an example process 2100 for the downsampling 2104, upsampling 2108, coordinate reading/splitting 2116, and coordinate pruning 2112 processes. For simplicity, the operations in FIG. 21 are illustrated in the 2D space, while the same rationale may be applied to the 3D space. In this example, the input point cloud A0 2102 occupy voxels at positions (0, 2), (0, 3), (0, 4), (0, 5), (1, 1), (1, 6), (2, 6), (3, 5), (4, 4), (5, 4), (6, 4), and (7, 4) 2118, in which the origin is zero based and in the upper left corner. Thus, the coordinate reader/splitter 2116 outputs the occupied coordinates as (0, 2), (0, 3), (0, 4), (0, 5), (1, 1), (1, 6), (2, 6), (3, 5), (4, 4), (5, 4), (6, 4), and (7, 4) 2118. By downsampling A0 2102 by a ratio of 2, the number of voxels is reduced by half in each dimension in the downsampled point cloud A1 2106, and a voxel is considered as occupied if any of corresponding 4 points is occupied in A0 2102. After upsampling A1 2106, the number of voxels resumes in A2 2110, and a voxel in A2 2110 is considered as occupied if the corresponding voxel is occupied in A1 2106. A2 2110 is denser than the input point cloud A0 2102. To remove/prune the points (voxels) from A2 2110 that are unoccupied in A0 2102, the occupied coordinate information is used by the coordinate pruning block. In the resulting point cloud A3 2114, only the voxels that are occupied in the original point cloud A0 are treated as occupied.

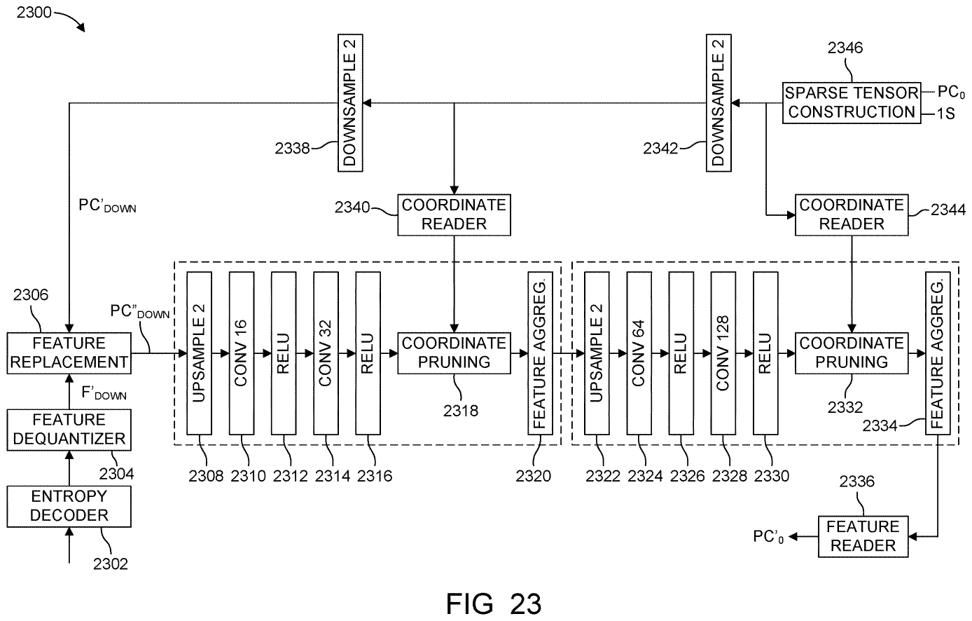

FIG. 22 is a block diagram illustrating an example decoder architecture according to some embodiments. An example feature decoder 2200 based on sparse 3D convolution, downsampling and upsampling is shown in FIG. 22 for some embodiments. The bitstream BS₁ 2202 is entropy decoded 2204 and feature dequantized 2206 to generate a downsampled feature set F′_{down}, followed by sequential upsampling using the geometry of PC₀ to enlarge and refine the features gradually. In FIG. 22, the bitstream BS₁ is decoded by the entropy decoder, followed by a dequantizer, leading to the downsampled feature set F′_{down}.

As shown in the upper right corner of FIG. 22, a 3D sparse tensor is constructed 2244 (solely) based on the geometry (coordinates) of PC₀. The tensor is downsampled 2240, 2236 sequentially, leading to a tensor PC′_{down}. PC′_{down} in FIG. 22 and PC_{down} for a feature encoder (not shown) may have the same geometry, but their features may be different for some embodiments. To upsample F′_{down}, F′_{down} is converted the geometry of PC′_{down}. To convert the geometry of F′_{down} to the geometry of PC′_{down}, the feature replacement block 2208 replaces the original features of PC′_{down} by F′_{down}, resulting in another sparse tensor PC″_{down}.

PC″_{down} is upsampled by two upsample processing blocks, where each block contains one upsample operator 2210, 2222 and two sparse 3D convolution layers. In FIG. 22, “Upsample 2” is a sparse tensor upsample operator 2210, 2222 with a ratio of 2. For some embodiments, an upsample 2 block may include a sparse tensor upsample operator 2210, 2222, and two sets of a convolutional decoder 2212, 2216, 2224, 2228 and a rectifier linear unit (ReLU) 2214, 2218, 2226, 2230. The upsample 2 block enlarges the size of the sparse tensor by 2 times along each dimension, similar to the upsample operator on “regular” 2D images. See FIG. 21 for an illustrative example. After each upsample processing block, the resulting tensor is refined with a respective coordinate reader 2238, 2242 and a coordinate pruning block 2220, 2232. FIG. 21 shows an illustrative example of coordinate pruning, which removes some of the occupied voxels of an input tensor and keeps the rest based on a set of input coordinates, which may be obtained from a coordinate reader. The coordinate pruning block 2220 removes some voxels (and the associated features) from the upsampled versions of PC″_{down}, and keeps only those voxels that also appear in the downsampled versions of PC₀. The output of the second coordinate pruning block 2232 is a tensor that has the same geometry as PC₀. This tensor is inputted into a feature reader 2234 to obtain the decoded feature set PC′₀.

FIG. 23 is a block diagram illustrating an example decoder architecture according to some embodiments. Compared to FIG. 22, the coordinate pruning block 2318, 2332 (and the feature aggregation block 2320, 2334 for some embodiments) is/are absorbed into the preceding upsampling processing block in FIG. 23 for some embodiments.

For some embodiments of the example decoder 2300, the tensor is downsampled 2342, 2338 sequentially, leading to a tensor PC′_{down}. In some embodiments, a bitstream is entropy decoded 2302 and feature dequantized 2304 to generate a downsampled feature set F′_{down}. To convert the geometry of F′_{down} to the geometry of PC′_{down}, the feature replacement block 2306 replaces the original features of PC′_{down} by F′_{down}, resulting in another sparse tensor PC″_{down}. For some embodiments, an upsample 2 block may include a sparse tensor upsample operator 2308, 2322, and two sets of a convolutional decoder 2310, 2314, 2324, 2328 and a rectifier linear unit (ReLU) 2312, 2316, 2326, 2330. For some embodiments, after each upsample processing block, the resulting tensor is refined with a respective coordinate reader 2340, 2344 and a coordinate pruning block 2318, 2332. The output of the second feature aggregation block 2334 is a tensor that has the same geometry as PC₀. This tensor is inputted into a feature reader 2336 to obtain the decoded feature set PC′₀.

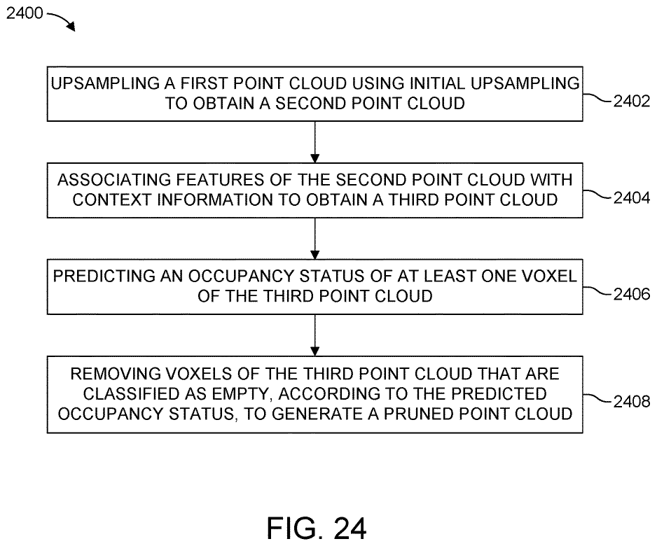

FIG. 24 is a flowchart illustrating an example process of context-aware voxel-based upsampling with pruning according to some embodiments. For some embodiments, an example process 2400 may include upsampling 2402 a first point cloud using initial upsampling to obtain a second point cloud. For some embodiments, the example process 2400 may further include associating 2404 features of the second point cloud with voxel-wise context information to obtain a third point cloud. For some embodiments, the example process 2400 may further include predicting 2406 an occupancy status of at least one voxel of the third point cloud. For some embodiments, the example process 2400 may further include removing 2408 voxels of the third point cloud that are classified as empty, according to the predicted occupancy status, to generate a pruned point cloud. For some embodiments, initial upsampling may include nearest-neighbor upsampling. For some embodiments, associating features may include concatenating features.

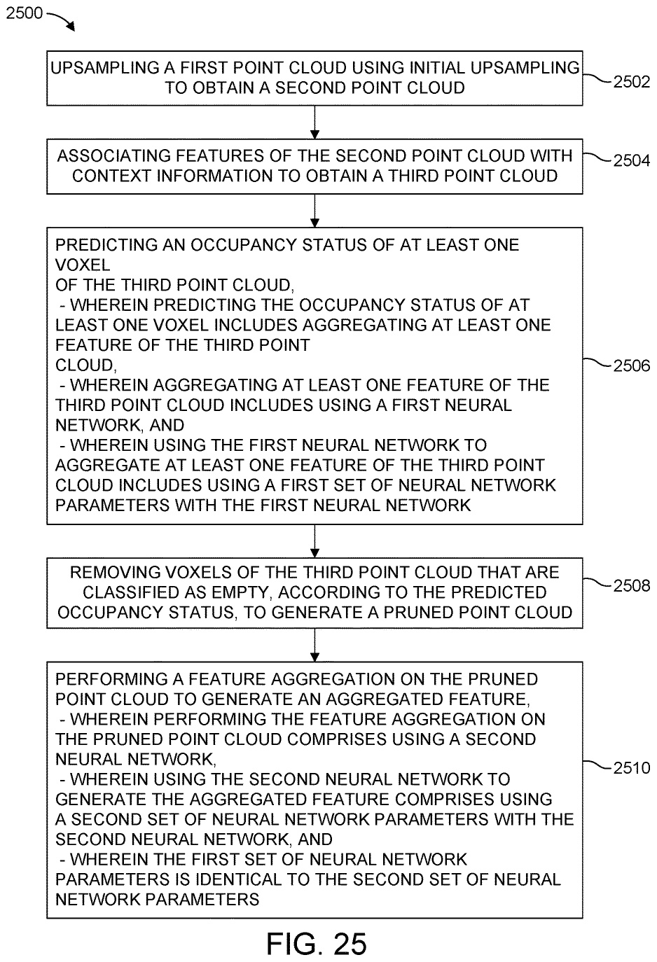

FIG. 25 is a flowchart illustrating an example process of context-aware voxel-based upsampling and feature aggregation according to some embodiments. For some embodiments, an example process 2500 may include upsampling 2502 a first point cloud using initial upsampling to obtain a second point cloud. For some embodiments, the example process 2500 may further include associating 2504 features of the second point cloud with context information to obtain a third point cloud. For some embodiments, the example process 2500 may further include predicting 2506 an occupancy status of at least one voxel of the third point cloud, wherein predicting the occupancy status of at least one voxel comprises aggregating at least one feature of the third point cloud, wherein aggregating at least one feature of the third point cloud comprises using a first neural network, and wherein using the first neural network to aggregate at least one feature of the third point cloud comprises using a first set of neural network parameters with the first neural network. For some embodiments, the example process 2500 may further include removing 2508 voxels of the third point cloud that are classified as empty, according to the predicted occupancy status, to generate a pruned point cloud. For some embodiments, the example process 2500 may further include performing 2510 a feature aggregation on the pruned point cloud to generate an aggregated feature, wherein performing the feature aggregation on the pruned point cloud comprises using a second neural network, wherein using the second neural network to generate the aggregated feature comprises using a second set of neural network parameters with the second neural network, and wherein the first set of neural network parameters is identical to the second set of neural network parameters.

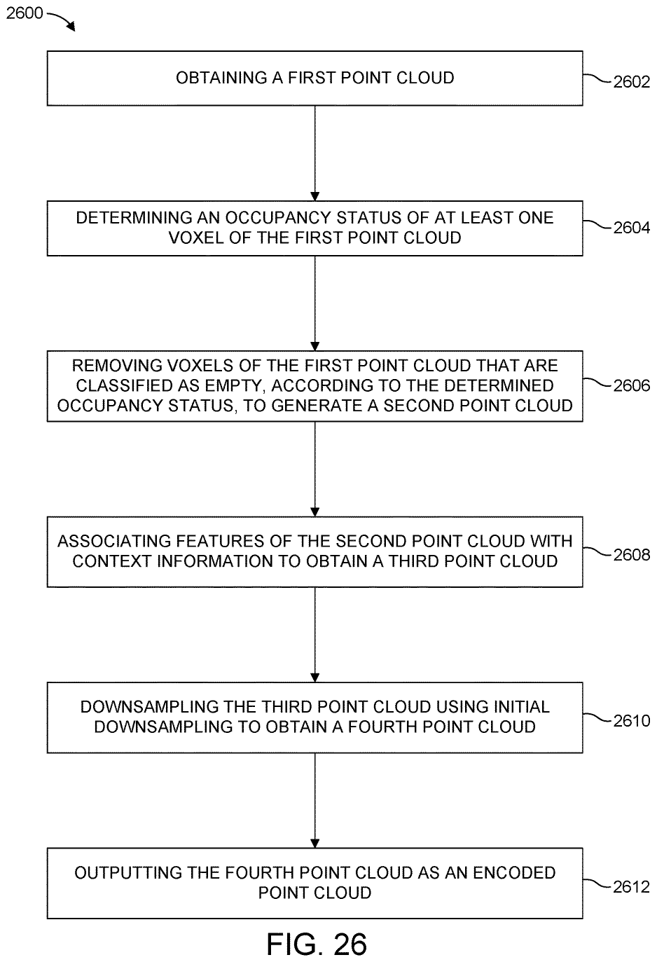

FIG. 26 is a flowchart illustrating an example process of encoding a bitstream according to some embodiments. For some embodiments, an example process 2600 may include obtaining 2602 a first point cloud. For some embodiments, the example process 2500 may further include determining 2604 an occupancy status of at least one voxel of the first point cloud. For some embodiments, the example process 2500 may further include removing 2606 voxels of the first point cloud that are classified as empty, according to the determined occupancy status, to generate a second point cloud. For some embodiments, the example process 2500 may further include associating 2608 features of the second point cloud with context information to obtain a third point cloud. For some embodiments, the example process 2500 may further include downsampling 2610 the third point cloud using initial downsampling to obtain a fourth point cloud. For some embodiments, the example process 2500 may further include outputting 2612 the fourth point cloud as an encoded point cloud.

For some embodiments, an apparatus may include one or more processors configured to: upsample a first point cloud using nearest-neighbor upsampling to obtain a second point cloud; concatenate features of the second point cloud with voxel-wise context information to obtain a third point cloud; predict occupancy status of at least one voxel of the third point cloud; and remove voxels of the third point cloud that are classified as empty, according to the predicted occupancy status.

While the methods and systems in accordance with some embodiments are discussed in the context of virtual reality (VR), some embodiments may be applied to mixed reality (MR)/augmented reality (AR) contexts as well. Also, although the term “head mounted display (HMD)” is used herein in accordance with some embodiments, some embodiments may be applied to a wearable device (which may or may not be attached to the head) capable of, e.g., VR, AR, and/or MR for some embodiments.

An example method in accordance with some embodiments may include upsampling a first point cloud using initial upsampling to obtain a second point cloud; associating features of the second point cloud with context information to obtain a third point cloud; predicting an occupancy status of at least one voxel of the third point cloud; and removing voxels of the third point cloud that are classified as empty, according to the predicted occupancy status, to generate a pruned point cloud.

For some embodiments of the example method, the initial upsampling may include nearest-neighbor upsampling.

For some embodiments of the example method, associating features may include concatenating the features of the second point cloud with the context information to obtain the third point cloud.

For some embodiments of the example method, predicting the occupancy status may be performed using a first neural network.

For some embodiments of the example method, predicting the occupancy status may predict a ground-truth occupancy status of at least one voxel.

For some embodiments of the example method, predicting the occupancy status may predict a likelihood that the at least one voxel is occupied.

For some embodiments of the example method, removing voxels of the third point cloud may remove voxels using a voxel pruning process.

Some embodiments of the example method may further include aggregating at least one feature of the second point cloud.

For some embodiments of the example method, the context information may be voxel-wise context information.

For some embodiments of the example method, predicting the occupancy status of at least one voxel may include: aggregating at least one feature of the third point cloud; processing the aggregated feature with multi-layer perception (MLP) layers to generate an MLP layer output; performing a softmax process on the MLP layer output to generate softmax output values; and performing thresholding of the softmax output values to generate the predicted occupancy status of at least one voxel of the third point cloud.

For some embodiments of the example method, thresholding of the softmax output values converts softmax output values greater than 0.5 into an output value of 1 and converts softmax output values equal to 0.5 or less into an output value of 0.

For some embodiments of the example method, predicting the occupancy status of at least one voxel may include: aggregating at least one feature of the third point cloud; and generating the predicted occupancy status of at least one voxel of the third point cloud based on the aggregated feature.

For some embodiments of the example method, aggregating at least one feature may include: repeating a cascading process one or more times, the cascading process may include: performing a sparse 3D convolution of an input point cloud to generate a convolution output point cloud; performing a nonlinear activation process on the convolution output point cloud to generate a nonlinear output point cloud; and preparing the nonlinear output point cloud to be the input point cloud if there is to be a next cycle of the cascading process, wherein the third point cloud is the input point cloud for a first cycle of the cascading process, and wherein a last cycle of the cascading process generates the aggregated feature.

Some embodiments of the example method may further include adding the third point cloud to the ReLU output point cloud of the last cycle of the cascading process.

For some embodiments of the example method, aggregating at least one feature may include: performing a sparse 3D convolution of an input point cloud to generate a convolution output point cloud; and performing a nonlinear activation process on the convolution output point cloud to generate the aggregated feature.

For some embodiments of the example method, the nonlinear activation process may be a rectifier linear unit (ReLU) activation process.

For some embodiments of the example method, aggregating at least one feature may include: repeating a first cascading process one or more times, the first cascading process may include: performing a first sparse 3D convolution of a first input point cloud to generate a first convolution output point cloud; performing a first nonlinear activation process on the first convolution output point cloud to generate a first nonlinear output point cloud; and preparing the first nonlinear output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process may include: performing a second sparse 3D convolution of a second input point cloud to generate a second convolution output point cloud; performing a second nonlinear activation process on the second convolution output point cloud to generate a second nonlinear output point cloud; and preparing the second nonlinear output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the example method, aggregating at least one feature may include: repeating a first cascading process one or more times, the first cascading process may include: performing a first sparse 3D convolution of a first input point cloud to generate a first convolution output point cloud; performing a first rectifier linear unit (ReLU) activation process on the first convolution output point cloud to a first generate a ReLU output point cloud; and preparing the first ReLU output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process may include: performing a second sparse 3D convolution of a second input point cloud to generate a second convolution output point cloud; performing a second rectifier linear unit (ReLU) activation process on the second convolution output point cloud to generate a second ReLU output point cloud; and preparing the second ReLU output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the example method, aggregating at least one feature may include: performing a self-attention process on the third point cloud; adding the third point cloud to the self-attention process output to generate an MLP process input; performing an MLP process on the MLP process input; and adding the MLP process input to the MLP process output to generate the aggregated feature.

For some embodiments of the example method, the self-attention process generates an output feature based on k nearest neighbors of a voxel of the third point cloud.

For some embodiments of the example method, aggregating at least one feature of the third point cloud may include performing a feature aggregation process two or more times.

Some embodiments of the example method may further include performing a feature decode on an input point cloud and a first bitstream to generate the first point cloud.

Some embodiments of the example method may further include performing a feature to residual conversion on the pruned point cloud to generate a residual output; and adding the pruned point cloud to the residual output to generate a decoded point cloud.

Some embodiments of the example method may further include performing a feature aggregation on the pruned point cloud to generate an aggregated feature, wherein the feature to residual conversion is performed on the aggregated feature.

Some embodiments of the example method may further include performing a feature aggregation on the pruned point cloud to generate an aggregated feature; and performing a context-aware upsampling process on the aggregated feature to generate a decoded point cloud.

An example apparatus in accordance with some embodiments may include a processor; and a non-transitory computer-readable medium storing instructions operative, when executed by the processor, to cause the apparatus to: upsample a first point cloud using nearest-neighbor upsampling to obtain a second point cloud; concatenate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

An example device in accordance with some embodiments may include an apparatus according to the example apparatus; and at least one of (i) an antenna configured to receive a signal, the signal including data representative of the image, (ii) a band limiter configured to limit the received signal to a band of frequencies that includes the data representative of the image, or (iii) a display configured to display the image.

Some embodiments of the example method may further include at least one of a TV, a cell phone, a tablet, and a set top box (STB).

An example apparatus in accordance with some embodiments may include an accessing unit configured to access data including a first point cloud; and a transmitter configured to transmit the data including the first point cloud.

An example method in accordance with some embodiments may include accessing data including a first point cloud; and transmitting the data including the first point cloud.

An example computer-readable medium in accordance with some embodiments may include instructions for causing one or more processors to: upsample a first point cloud using nearest-neighbor upsampling to obtain a second point cloud; concatenate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

An example computer program product in accordance with some embodiments may include instructions which, when the program is executed by one or more processors, causes the one or more processors to: upsample a first point cloud using nearest-neighbor upsampling to obtain a second point cloud; concatenate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

An example method in accordance with some embodiments may include performing context aware upsampling of a first point cloud to determine an upsampled second point cloud, wherein the context aware upsampling may include: associating features of a third point cloud with context information, the third point cloud being based at least in part on an initial upsampled version of the first point cloud; and removing voxels of a fourth point cloud predicted to be empty based at least in part on the context information from the third point cloud to generate the upscaled second point cloud.

An additional example method in accordance with some embodiments may include: upsampling a first point cloud using initial upsampling to obtain a second point cloud; associating features of the second point cloud with context information to obtain a third point cloud; predicting an occupancy status of at least one voxel of the third point cloud, wherein predicting the occupancy status of at least one voxel comprises aggregating at least one feature of the third point cloud, wherein aggregating at least one feature of the third point cloud comprises using a first neural network, and wherein using the first neural network to aggregate at least one feature of the third point cloud comprises using a first set of neural network parameters with the first neural network; removing voxels of the third point cloud that are classified as empty, according to the predicted occupancy status, to generate a pruned point cloud; and performing a feature aggregation on the pruned point cloud to generate an aggregated feature, wherein performing the feature aggregation on the pruned point cloud comprises using a second neural network, wherein using the second neural network to generate the aggregated feature comprises using a second set of neural network parameters with the second neural network, and wherein the first set of neural network parameters is identical to the second set of neural network parameters.

Some embodiments of the additional example method may further include aggregating at least one feature of the second point cloud.

For some embodiments of the additional example method, aggregating at least one feature of the second point cloud may include using a third neural network, using the third neural network to aggregate at least one feature of the second point cloud may include using a third set of neural network parameters with the third neural network, and the third set of neural network parameters may be identical to the first set of neural network parameters.

Some embodiments of the additional example method may further include performing a feature decode on an input point cloud and a first bitstream to generate the first point cloud.

Some embodiments of the additional example method may further include: performing a feature to residual conversion on the pruned point cloud to generate a residual output; and adding the pruned point cloud to the residual output to generate a decoded point cloud.

For some embodiments of the additional example method, the feature to residual conversion may be performed on the aggregated feature.

Some embodiments of the additional example method may further include performing a context-aware upsampling process on the aggregated feature to generate a decoded point cloud.

For some embodiments of the additional example method, the initial upsampling may include nearest-neighbor upsampling.

For some embodiments of the additional example method, associating features may include concatenating the features of the second point cloud with the context information to obtain the third point cloud.

For some embodiments of the additional example method, predicting the occupancy status may predict a ground-truth occupancy status of at least one voxel.

For some embodiments of the additional example method, predicting the occupancy status may predict a likelihood that the at least one voxel is occupied.

For some embodiments of the additional example method, removing voxels of the third point cloud may remove voxels using a voxel pruning process.

For some embodiments of the additional example method, the context information may be voxel-wise context information.

For some embodiments of the additional example method, predicting the occupancy status of at least one voxel may include: processing the aggregated feature with multi-layer perception (MLP) layers to generate an MLP layer output; performing a softmax process on the MLP layer output to generate softmax output values; and performing thresholding of the softmax output values to generate the predicted occupancy status of at least one voxel of the third point cloud.

For some embodiments of the additional example method, thresholding of the softmax output values may convert softmax output values greater than 0.5 into an output value of 1 and converts softmax output values equal to 0.5 or less into an output value of 0.

For some embodiments of the additional example method, predicting the occupancy status of at least one voxel may include: aggregating at least one feature of the third point cloud; and generating the predicted occupancy status of at least one voxel of the third point cloud based on the aggregated feature.

For some embodiments of the additional example method, aggregating at least one feature of the third point cloud may include: repeating a cascading process one or more times, the cascading process may include: performing a sparse 3D convolution of an input point cloud to generate a convolution output point cloud; performing a nonlinear activation process on the convolution output point cloud to generate a nonlinear output point cloud; and preparing the nonlinear output point cloud to be the input point cloud if there is to be a next cycle of the cascading process, the third point cloud may be the input point cloud for a first cycle of the cascading process, and a last cycle of the cascading process may generate the aggregated feature.

Some embodiments of the additional example method may further include adding the third point cloud to the ReLU output point cloud of the last cycle of the cascading process.

For some embodiments of the additional example method, aggregating at least one feature may include: performing a sparse 3D convolution of an input point cloud to generate a convolution output point cloud; and performing a nonlinear activation process on the convolution output point cloud to generate the aggregated feature.

For some embodiments of the additional example method, the nonlinear activation process may include a rectifier linear unit (ReLU) activation process, and the nonlinear output point cloud comprises a ReLU output point cloud.

For some embodiments of the additional example method, aggregating at least one feature of the third point cloud may include: repeating a first cascading process one or more times, the first cascading process may include: performing a first sparse 3D convolution of a first input point cloud to generate a first convolution output point cloud; performing a first nonlinear activation process on the first convolution output point cloud to generate a first nonlinear output point cloud; and preparing the first nonlinear output point cloud to be the first input point cloud if there is to be a next cycle of the first cascading process, wherein the third point cloud may be the first input point cloud for a first cycle of the first cascading process, wherein a last cycle of the first cascading process may generate a first cascading process output; repeating a second cascading process one or more times, the second cascading process may include: performing a second sparse 3D convolution of a second input point cloud to generate a second convolution output point cloud; performing a second nonlinear activation process on the second convolution output point cloud to generate a second nonlinear output point cloud; and preparing the second nonlinear output point cloud to be the second input point cloud if there is to be a next cycle of the second cascading process, wherein the third point cloud may be the second input point cloud for a first cycle of the second cascading process, wherein a last cycle of the second cascading process may generate a second cascading process output; concatenating the first cascading process output and the second cascading process output to generate a concatenation output; and adding the third point cloud to the concatenation output to generate the aggregated feature.

For some embodiments of the additional example method, aggregating at least one feature may include: repeating a first cascading process one or more times, the first cascading process may include: performing a first sparse 3D convolution of a first input point cloud to generate a first convolution output point cloud; performing a first rectifier linear unit (ReLU) activation process on the first convolution output point cloud to a first generate a ReLU output point cloud; and preparing the first ReLU output point cloud to be the first input point cloud if there is to be a next cycle of the first cascading process, wherein the third point cloud may be the first input point cloud for a first cycle of the first cascading process, wherein a last cycle of the first cascading process may generate a first cascading process output; repeating a second cascading process one or more times, the second cascading process may include: performing a second sparse 3D convolution of a second input point cloud to generate a second convolution output point cloud; performing a second rectifier linear unit (ReLU) activation process on the second convolution output point cloud to generate a second ReLU output point cloud; and preparing the second ReLU output point cloud to be the second input point cloud if there is to be a next cycle of the second cascading process, wherein the third point cloud may be the second input point cloud for a first cycle of the second cascading process, wherein a last cycle of the second cascading process may generate a second cascading process output; concatenating the first cascading process output and the second cascading process output to generate a concatenation output; and adding the third point cloud to the concatenation output to generate the aggregated feature.

For some embodiments of the additional example method, aggregating at least one feature may include: performing a self-attention process on the third point cloud; adding the third point cloud to the self-attention process output to generate an MLP process input; performing an MLP process on the MLP process input; and adding the MLP process input to the MLP process output to generate the aggregated feature;

For some embodiments of the additional example method, the self-attention process may generate an output feature based on k nearest neighbors of a voxel of the third point cloud.

For some embodiments of the additional example method, aggregating at least one feature of the third point cloud may include performing a feature aggregation process two or more times.

For some embodiments of the additional example method, the first set of neural network parameters and the second set of neural network parameters may be the same set of neural network parameters, the same set of neural network parameters being used by at least the first neural network and the second neural network.

For some embodiments of the additional example method, the first set of neural network parameters and the second set of neural network parameters may be distinct but identical sets of neural network parameters.

An additional example apparatus in accordance with some embodiments may include: a processor; and a non-transitory computer-readable medium storing instructions operative, when executed by the processor, to cause the apparatus to perform any one of the methods listed above.

A first example method/apparatus in accordance with some embodiments may include: upsampling a first point cloud using initial upsampling to obtain a second point cloud; associating features of the second point cloud with context information to obtain a third point cloud; predicting an occupancy status of at least one voxel of the third point cloud; and removing voxels of the third point cloud that are classified as empty, according to the predicted occupancy status, to generate a pruned point cloud.

For some embodiments of the first example method, the initial upsampling includes nearest-neighbor upsampling.

For some embodiments of the first example method, associating features includes concatenating the features of the second point cloud with the context information to obtain the third point cloud.

For some embodiments of the first example method, the context information is voxel-wise context information.

For some embodiments of the first example method, the context information includes a context point cloud.

For some embodiments of the first example method, the context information includes information about the second point cloud.

For some embodiments of the first example method, the context information includes information about voxel occupancy status of the second point cloud.

For some embodiments of the first example method, the context information includes information regarding a position of a child voxel relative to a position of a parent voxel of the first point cloud.

For some embodiments of the first example method, the context information includes coordinate information regarding a position of an occupied voxel of at least one of the first and second point clouds.

For some embodiments of the first example method, the context information includes coordinate information, and the coordinate information is in a form of one of Euclidean coordinates, spherical coordinates, and cylindrical coordinates.

For some embodiments of the first example method, the context information provides known information regarding the first point cloud additional to information available to the initial upsampling of the first point cloud.

For some embodiments of the first example method, the context information includes a bit depth of the second point cloud.

Some embodiments of the first example method may further include performing a feature decode on an input point cloud and a first bitstream to generate the first point cloud.

Some embodiments of the first example method may further include: performing a feature aggregation on the pruned point cloud to generate an aggregated feature; and performing a context-aware upsampling process on the aggregated feature to generate a decoded point cloud.

Some embodiments of the first example method may further include: performing a feature to residual conversion on the pruned point cloud to generate a residual output; and adding the pruned point cloud to the residual output to generate a decoded point cloud.

Some embodiments of the first example method may further include performing a feature aggregation on the pruned point cloud to generate an aggregated feature, wherein the feature to residual conversion is performed on the aggregated feature.

For some embodiments of the first example method, predicting the occupancy status is performed using a first neural network.

For some embodiments of the first example method, predicting the occupancy status predicts a ground-truth occupancy status of at least one voxel.

For some embodiments of the first example method, predicting the occupancy status predicts a likelihood that the at least one voxel is occupied.

For some embodiments of the first example method, removing voxels of the third point cloud removes voxels using a voxel pruning process.

Some embodiments of the first example method may further include aggregating at least one feature of the second point cloud.

For some embodiments of the first example method, predicting the occupancy status of at least one voxel includes: aggregating at least one feature of the third point cloud; processing the aggregated feature with multi-layer perception (MLP) layers to generate an MLP layer output; performing a softmax process on the MLP layer output to generate softmax output values; and performing thresholding of the softmax output values to generate the predicted occupancy status of at least one voxel of the third point cloud.

For some embodiments of the first example method, thresholding of the softmax output values converts softmax output values greater than 0.5 into an output value of 1 and converts softmax output values equal to 0.5 or less into an output value of 0.

For some embodiments of the first example method, predicting the occupancy status of at least one voxel includes: aggregating at least one feature of the third point cloud; and generating the predicted occupancy status of at least one voxel of the third point cloud based on the aggregated feature.

For some embodiments of the first example method, aggregating at least one feature includes: repeating a cascading process one or more times, the cascading process including: performing a sparse 3D convolution of an input point cloud to generate a convolution output point cloud; performing a nonlinear activation process on the convolution output point cloud to generate a nonlinear output point cloud; and preparing the nonlinear output point cloud to be the input point cloud if there is to be a next cycle of the cascading process, wherein the third point cloud is the input point cloud for a first cycle of the cascading process, and wherein a last cycle of the cascading process generates the aggregated feature.

Some embodiments of the first example method may further include adding the third point cloud to the ReLU output point cloud of the last cycle of the cascading process.

For some embodiments of the first example method, aggregating at least one feature includes: performing a sparse 3D convolution of an input point cloud to generate a convolution output point cloud; and performing a nonlinear activation process on the convolution output point cloud to generate the aggregated feature.

For some embodiments of the first example method, the nonlinear activation process includes a rectifier linear unit (ReLU) activation process, and the nonlinear output point cloud includes a ReLU output point cloud.

For some embodiments of the first example method, aggregating at least one feature includes: repeating a first cascading process one or more times, the first cascading process including: performing a first sparse 3D convolution of a first input point cloud to generate a first convolution output point cloud; performing a first nonlinear activation process on the first convolution output point cloud to generate a first nonlinear output point cloud; and preparing the first nonlinear output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second nonlinear activation process on the second convolution output point cloud to generate a second nonlinear output point cloud; and preparing the second nonlinear output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the first example method, aggregating at least one feature includes: repeating a first cascading process one or more times, the first cascading process including: performing a first sparse 3D convolution of a first input point cloud to generate a first convolution output point cloud; performing a first rectifier linear unit (ReLU) activation process on the first convolution output point cloud to a first generate a ReLU output point cloud; and preparing the first ReLU output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second rectifier linear unit (ReLU) activation process on the second convolution output point cloud to generate a second ReLU output point cloud; and preparing the second ReLU output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the first example method, aggregating at least one feature includes: performing a self-attention process on the third point cloud; adding the third point cloud to the self-attention process output to generate an MLP process input; performing an MLP process on the MLP process input; and adding the MLP process input to the MLP process output to generate the aggregated feature;

For some embodiments of the first example method, the self-attention process generates an output feature based on k nearest neighbors of a voxel of the third point cloud.

For some embodiments of the first example method, aggregating at least one feature of the third point cloud includes performing a feature aggregation process two or more times.

A first example method/apparatus in accordance with some embodiments may include: a processor; and a non-transitory computer-readable medium storing instructions operative, when executed by the processor, to cause the apparatus to: upsample a first point cloud using initial upsampling to obtain a second point cloud; associate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

For some embodiments of the first example apparatus, the initial upsampling includes nearest-neighbor upsampling.

For some embodiments of the first example apparatus, associating features includes concatenating the features of the second point cloud with the context information to obtain the third point cloud.

An example device in accordance with some embodiments may include: an apparatus according to an apparatus listed above; and at least one of (i) an antenna configured to receive a signal, the signal including data representative of the image, (ii) a band limiter configured to limit the received signal to a band of frequencies that includes the data representative of the image, or (iii) a display configured to display the image.

Some embodiments of the example device may further include at least one of a TV, a cell phone, a tablet, and a set top box (STB).

An example computer-readable medium in accordance with some embodiments may include instructions for causing one or more processors to: upsample a first point cloud using initial upsampling to obtain a second point cloud; associate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

An example computer program product in accordance with some embodiments may include instructions which, when the program is executed by one or more processors, causes the one or more processors to: upsample a first point cloud using initial upsampling to obtain a second point cloud; associate features of the second point cloud with context information to obtain a third point cloud; predict an occupancy status of at least one voxel of the third point cloud; and remove voxels of the third point cloud that are classified as empty, according to the predicted occupancy status, to generate a pruned point cloud.

A second example method in accordance with some embodiments may include performing context aware upsampling of a first point cloud to determine an upsampled second point cloud, wherein the context aware upsampling includes: associating features of a third point cloud with context information, the third point cloud being based at least in part on an initial upsampled version of the first point cloud; and removing voxels of a fourth point cloud predicted to be empty based at least in part on the context information from the third point cloud to generate the upscaled second point cloud.

A third example method in accordance with some embodiments may include: upsampling a first point cloud using initial upsampling to obtain a second point cloud; associating features of the second point cloud with context information to obtain a third point cloud; predicting an occupancy status of at least one voxel of the third point cloud, wherein predicting the occupancy status of at least one voxel includes aggregating at least one feature of the third point cloud, wherein aggregating at least one feature of the third point cloud includes using a first neural network, and wherein using the first neural network to aggregate at least one feature of the third point cloud includes using a first set of neural network parameters with the first neural network; removing voxels of the third point cloud that are classified as empty, according to the predicted occupancy status, to generate a pruned point cloud; and performing a feature aggregation on the pruned point cloud to generate an aggregated feature, wherein performing the feature aggregation on the pruned point cloud includes using a second neural network, wherein using the second neural network to generate the aggregated feature includes using a second set of neural network parameters with the second neural network, and wherein the first set of neural network parameters is identical to the second set of neural network parameters.

Some embodiments of the third example method may further include aggregating at least one feature of the second point cloud.

For some embodiments of the third example method, wherein aggregating at least one feature of the second point cloud includes using a third neural network, wherein using the third neural network to aggregate at least one feature of the second point cloud includes using a third set of neural network parameters with the third neural network, and wherein the third set of neural network parameters is identical to the first set of neural network parameters.

For some embodiments of the third example method, the initial upsampling includes nearest-neighbor upsampling.

For some embodiments of the third example method, associating features includes concatenating the features of the second point cloud with the context information to obtain the third point cloud.

For some embodiments of the third example method, associating features includes concatenating the features of the second point cloud with the context information to obtain the third point cloud.

For some embodiments of the third example method, the context information is voxel-wise context information.

Some embodiments of the third example method may further include performing a feature decode on an input point cloud and a first bitstream to generate the first point cloud.

Some embodiments of the third example method may further include performing a context-aware upsampling process on the aggregated feature to generate a decoded point cloud.

Some embodiments of the third example method may further include performing a feature to residual conversion on the pruned point cloud to generate a residual output; and adding the pruned point cloud to the residual output to generate a decoded point cloud.

For some embodiments of the third example method, the feature to residual conversion is performed on the aggregated feature.

For some embodiments of the third example method, predicting the occupancy status predicts a ground-truth occupancy status of at least one voxel.

For some embodiments of the third example method, predicting the occupancy status predicts a likelihood that the at least one voxel is occupied.

For some embodiments of the third example method, removing voxels of the third point cloud removes voxels using a voxel pruning process.

For some embodiments of the third example method, predicting the occupancy status of at least one voxel further includes: processing the aggregated feature with multi-layer perception (MLP) layers to generate an MLP layer output; performing a softmax process on the MLP layer output to generate softmax output values; and performing thresholding of the softmax output values to generate the predicted occupancy status of at least one voxel of the third point cloud.

For some embodiments of the third example method, thresholding of the softmax output values converts softmax output values greater than 0.5 into an output value of 1 and converts softmax output values equal to 0.5 or less into an output value of 0.

For some embodiments of the third example method, predicting the occupancy status of at least one voxel includes: aggregating at least one feature of the third point cloud; and generating the predicted occupancy status of at least one voxel of the third point cloud based on the aggregated feature.

For some embodiments of the third example method, aggregating at least one feature of the third point cloud includes: repeating a cascading process one or more times, the cascading process including: performing a sparse 3D convolution of an input point cloud to generate a convolution output point cloud; performing a nonlinear activation process on the convolution output point cloud to generate a nonlinear output point cloud; and preparing the nonlinear output point cloud to be the input point cloud if there is to be a next cycle of the cascading process, wherein the third point cloud is the input point cloud for a first cycle of the cascading process, and wherein a last cycle of the cascading process generates the aggregated feature.

Some embodiments of the third example method may further include adding the third point cloud to the ReLU output point cloud of the last cycle of the cascading process.

For some embodiments of the third example method, aggregating at least one feature includes: performing a sparse 3D convolution of an input point cloud to generate a convolution output point cloud; and performing a nonlinear activation process on the convolution output point cloud to generate the aggregated feature.

For some embodiments of the third example method, the nonlinear activation process includes a rectifier linear unit (ReLU) activation process, and the nonlinear output point cloud includes a ReLU output point cloud.

For some embodiments of the third example method, aggregating at least one feature of the third point cloud includes: repeating a first cascading process one or more times, the first cascading process including: performing a first sparse 3D convolution of a first input point cloud to generate a first convolution output point cloud; performing a first nonlinear activation process on the first convolution output point cloud to generate a first nonlinear output point cloud; and preparing the first nonlinear output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second nonlinear activation process on the second convolution output point cloud to generate a second nonlinear output point cloud; and preparing the second nonlinear output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the third example method, aggregating at least one feature includes: repeating a first cascading process one or more times, the first cascading process including: performing a first sparse 3D convolution of a first input point cloud to generate a first convolution output point cloud; performing a first rectifier linear unit (ReLU) activation process on the first convolution output point cloud to a first generate a ReLU output point cloud; and preparing the first ReLU output point cloud to be the first input point cloud if there is to be a next cycle of the first cascading process, wherein the third point cloud is the first input point cloud for a first cycle of the first cascading process, wherein a last cycle of the first cascading process generates a first cascading process output; repeating a second cascading process one or more times, the second cascading process including: performing a second sparse 3D convolution of a second input point cloud to generate a second convolution output point cloud; performing a second rectifier linear unit (ReLU) activation process on the second convolution output point cloud to generate a second ReLU output point cloud; and preparing the second ReLU output point cloud to be the second input point cloud if there is to be a next cycle of the second cascading process, wherein the third point cloud is the second input point cloud for a first cycle of the second cascading process, wherein a last cycle of the second cascading process generates a second cascading process output; concatenating the first cascading process output and the second cascading process output to generate a concatenation output; and adding the third point cloud to the concatenation output to generate the aggregated feature.

For some embodiments of the third example method, aggregating at least one feature includes: performing a self-attention process on the third point cloud; adding the third point cloud to the self-attention process output to generate an MLP process input; performing an MLP process on the MLP process input; and adding the MLP process input to the MLP process output to generate the aggregated feature;

For some embodiments of the third example method, the self-attention process generates an output feature based on k nearest neighbors of a voxel of the third point cloud.

For some embodiments of the third example method, aggregating at least one feature of the third point cloud includes performing a feature aggregation process two or more times.

For some embodiments of the third example method, the first set of neural network parameters and the second set of neural network parameters are the same set of neural network parameters, the same set of neural network parameters being used by at least the first neural network and the second neural network.

For some embodiments of the third example method, the first set of neural network parameters and the second set of neural network parameters are distinct but identical sets of neural network parameters.

A fourth example method in accordance with some embodiments may include: obtaining a first point cloud; determining an occupancy status of at least one voxel of the first point cloud; removing voxels of the first point cloud that are classified as empty, according to the determined occupancy status, to generate a second point cloud; associating features of the second point cloud with context information to obtain a third point cloud; downsampling the third point cloud using initial downsampling to obtain a fourth point cloud; and outputting the fourth point cloud as an encoded point cloud.

A fourth example apparatus in accordance with some embodiments may include: a processor; and a non-transitory computer-readable medium storing instructions operative, when executed by the processor, to cause the apparatus to: obtain a first point cloud; determine an occupancy status of at least one voxel of the first point cloud; remove voxels of the first point cloud that are classified as empty, according to the determined occupancy status, to generate a second point cloud; associate features of the second point cloud with context information to obtain a third point cloud; downsample the third point cloud using initial downsampling to obtain a fourth point cloud; and output the fourth point cloud as an encoded point cloud.

A fifth example method/apparatus in accordance with some embodiments may include: accessing data including a first point cloud; and transmitting the data including the first point cloud.

A fifth example method/apparatus in accordance with some embodiments may include: an accessing unit configured to access data including a first point cloud; and a transmitter configured to transmit the data including the first point cloud.

A sixth example method/apparatus in accordance with some embodiments may include: a processor; and a non-transitory computer-readable medium storing instructions operative, when executed by the processor, to cause the apparatus to perform any one of the methods listed above.

A seventh example method/apparatus in accordance with some embodiments may include at least one processor configured to perform any one of the methods listed above.

An eighth example method/apparatus in accordance with some embodiments may include a computer-readable medium storing instructions for causing one or more processors to perform any one of the methods listed above.

A ninth example method/apparatus in accordance with some embodiments may include at least one processor and at least one non-transitory computer-readable medium storing instructions for causing the at least one processor to perform any one of the methods listed above.

An example signal in accordance with some embodiments may include a bitstream generated according to any one of the methods listed above.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present disclosure, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

The terms HDR (high dynamic range) and SDR (standard dynamic range) often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.”

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
upsampling a first point cloud using initial upsampling to obtain a second point cloud;
associating features of the second point cloud with a context information point cloud to obtain a third point cloud;
predicting an occupancy status of at least one voxel of the third point cloud; and
removing voxels of the third point cloud that are classified as empty, according to the predicted occupancy status, to generate a pruned point cloud.

2. The method of claim 1, wherein the initial upsampling comprises nearest-neighbor upsampling.

3. The method claim 1, wherein associating features comprises concatenating the features of the second point cloud with the context information point cloud to obtain the third point cloud.

4. The method of claim 1, wherein the context information point cloud comprises voxel-wise context information.

5. (canceled)

6. The method of claim 1, wherein the context information point cloud comprises information about the second point cloud.

7. The method of claim 1, wherein the context information point cloud comprises information about voxel occupancy status of the second point cloud.

8. The method of claim 1, wherein the context information point cloud comprises information regarding a position of a child voxel relative to a position of a parent voxel of the first point cloud.

9. The method of claim 1, wherein the context information point cloud comprises coordinate information regarding a position of an occupied voxel of at least one of the first and second point clouds.

10. (canceled)

11. The method of claim 1, wherein the context information point cloud provides known information regarding the first point cloud additional to information available to the initial upsampling of the first point cloud.

12. The method of claim 1, wherein the context information comprises a bit depth of the second point cloud.

13. The method of claim 1, further comprising performing a feature decode on an input point cloud and a first bitstream to generate the first point cloud.

14. The method of claim 13, further comprising:
performing a feature aggregation on the pruned point cloud to generate an aggregated feature; and
performing a context-aware upsampling process on the aggregated feature to generate a decoded point cloud.

15. The method of claim 13, further comprising:
performing a feature to residual conversion on the pruned point cloud to generate a residual output; and
adding the pruned point cloud to the residual output to generate a decoded point cloud.

16. The method of claim 15, further comprising:
performing a feature aggregation on the pruned point cloud to generate an aggregated feature,
wherein the feature to residual conversion is performed on the aggregated feature.

17. The method of claim 1, wherein predicting the occupancy status is performed using a first neural network.

18. The method of claim 1, wherein predicting the occupancy status predicts a ground-truth occupancy status of at least one voxel.

19. The method of claim 1, wherein predicting the occupancy status predicts a likelihood that the at least one voxel is occupied.

20. (canceled)

21. The method of claim 1, further comprising aggregating at least one feature of the second point cloud.

22-33. (canceled)

34. An apparatus comprising:
a processor; and
a non-transitory computer-readable medium storing instructions operative, when executed by the processor, to cause the apparatus to:
upsample a first point cloud using initial upsampling to obtain a second point cloud;
associate features of the second point cloud with a context information point cloud to obtain a third point cloud;
predict an occupancy status of at least one voxel of the third point cloud; and
remove voxels of the third point cloud that are classified as empty, according to the predicted occupancy status, to generate a pruned point cloud.

35-40. (canceled)

41. A method comprising:
performing context aware upsampling of a first point cloud to determine an upsampled second point cloud,
wherein the context aware upsampling comprises:
associating features of a third point cloud with a context information point cloud, the third point cloud being based at least in part on an initial upsampled version of the first point cloud; and
removing voxels of a fourth point cloud predicted to be empty based at least in part on the context information point cloud from the third point cloud to generate the unsampled second point cloud.

42-78. (canceled)
